(19) United States
(12) Patent Application Publication
(10) Pub. No.: US 2021/0027796 A1
(43) Pub. Date: Jan. 28, 2021

(54) NON-TRANSITORY COMPUTER-READABLE STORAGE MEDIUM FOR STORING DETECTION PROGRAM, DETECTION METHOD, AND DETECTION APPARATUS

(71) Applicant: FUJITSU LIMITED, Kawasaki-shi (JP)

(72) Inventors: TARO TOGAWA, Kawasaki (JP); Sayuri Nakayama, Kawasaki (JP); Kiyonori Morioka, Kawasaki (JP)

(73) Assignee: FUJITSU LIMITED, Kawasaki-shi (JP)

(21) Appl. No.: 16/931,526

(22) Filed: Jul. 17, 2020

(30) Foreign Application Priority Data
Jul. 24, 2019 (JP) 2019-136079

(51) Int. Cl. G10L 21/0208; G06N 20/00; G10L 17/04; G10L 21/028

(52) U.S. Cl. CPC G10L 21/0208; G06N 20/00; G10L 2021/02087; G10L 21/028; G10L 17/04

(57) ABSTRACT

A detection method implemented by a computer, the detection method includes: acquiring voice information containing voices of a plurality of speakers; detecting a first speech segment of a first speaker among the plurality of speakers included in the voice information based on a first acoustic feature of the first speaker, the first acoustic feature being obtained by performing a machine learning; and detecting a second speech segment of a second speaker among the plurality of speakers based on a second acoustic feature, the second acoustic feature being an acoustic feature included in the voice information associated with a predetermined time range, the predetermined time range being a time range outside the first speech segment.

### CROSS-REFERENCE TO RELATED APPLICATION

This application is based upon and claims the benefit of priority of the prior Japanese Patent Application No. 2019-136079, filed on Jul. 24, 2019, the entire contents of which are incorporated herein by reference.

### FIELD

The embodiments discussed herein are related to a non-transitory computer-readable storage medium for storing a detection program, a detection method, a detection apparatus, and the like.

### BACKGROUND

It is a recent trend in stores selling a variety of products to set up in-store cameras in an attempt to obtain information on demands for and improvements in corporate services and products through analyses of behaviors of customers in shot videos. Also, regarding a conversation between a customer and a store clerk, if the store clerk is able to wear a microphone during the conversation with the customer and to record voices of the customer, then information on demands for and improvements in cooperate services and products is potentially available through analyses of the recorded voices of the customer.

The voices recorded with the microphone on the store clerk contain a mixture of voices of the store clerk and voices of the customer, and extraction of the voices of the customer from the mixed voices is expected. For example, there is a related art configured to determine whether or not an inputted voice is a voice of a registered speaker based on distribution of similarities of a voice of the registered speaker registered in advance to the inputted voices. The use of this related art makes it possible to specify the voices of the store clerk in the mixture of voices of the store clerk and the voice of the customer and to extract the voices other than the voices of the store clerk as the voices of the customer.

FIG. 22 is a diagram for describing processing to specify a speech segment of the customer by using the related art. The vertical axis in FIG. 22 is the axis corresponding to a sound volume (or a signal-to-noise ratio (SNR)) and the horizontal axis therein is the axis corresponding to the time. A line 1a indicates a relation between a sound volume and the time of an inputted voice. The microphone on the store clerk is assumed to be located close to the customer in the case of FIG. 22. In the following description, an apparatus configured to execute the related art will be simply referred to as the apparatus.

The apparatus registers the voice of the store clerk in advance and specifies a speech segment T_{A} of the store clerk based on the distribution of similarities of the inputted voices being the mixture of the voice of the store clerk and the voice of the customer to the registered voice. The apparatus detects a segment T_{B} as a speech segment of the customer which has a sound volume equal to or above a threshold Th from the speech segments other than the speech segment T_{A} of the store clerk, and extracts the voice in the speech segment T_{B} as the voice of the customer.

Examples of the related art include Japanese Laid-open Patent Publications No. 2007-27918, 2013-140534, and 2014-145932.

### SUMMARY

According to an aspect of the embodiments, provided is a detection method implemented by a computer. The detection method includes: acquiring voice information containing voices of a plurality of speakers; detecting a first speech segment of a first speaker among the plurality of speakers included in the voice information based on a first acoustic feature of the first speaker, the first acoustic feature being obtained by performing a machine learning; and detecting a second speech segment of a second speaker among the plurality of speakers based on a second acoustic feature, the second acoustic feature being an acoustic feature included in the voice information associated with a predetermined time range, the predetermined time range being a time range outside the first speech segment.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram (1) for describing processing of a detection apparatus according to Embodiment 1;

FIG. 2 is a diagram (2) for describing the processing of the detection apparatus according to Embodiment 1;

FIG. 3 illustrates an example of a system according to Embodiment 1;

FIG. 4 is a functional block diagram illustrating a configuration of the detection apparatus according to Embodiment 1;

FIG. 5 illustrates an example of acoustic feature distribution;

FIG. 6 is a flowchart illustrating processing procedures of the detection apparatus according to Embodiment 1;

FIG. 7 is a diagram (1) for describing processing of a detection apparatus according to Embodiment 2;

FIG. 8 is a diagram (2) for describing the processing of the detection apparatus according to Embodiment 2;

FIG. 9 is a diagram (3) for describing the processing of the detection apparatus according to Embodiment 2;

FIG. 10 is a functional block diagram illustrating a configuration of the detection apparatus according to Embodiment 2;

FIG. 11 illustrates an example of a data structure of learned acoustic feature information according to Embodiment 2;

FIG. 12 is a flowchart illustrating processing procedures of the detection apparatus according to Embodiment 2;

FIG. 13 is a diagram for describing other processing of the detection apparatus;

FIG. 14 illustrates an example of a system according to Embodiment 3;

FIG. 15 is a functional block diagram illustrating a configuration of a detection apparatus according to Embodiment 3;

FIG. 16 is a functional block diagram illustrating a configuration of a voice recognition apparatus according to Embodiment 3;

FIG. 17 is a flowchart illustrating processing procedures of the detection apparatus according to Embodiment 3;

FIG. 18 illustrates an example of a system according to Embodiment 4;

FIG. 19 is a functional block diagram illustrating a configuration of a detection apparatus according to Embodiment 4;

FIG. 20 is a flowchart illustrating processing procedures of the detection apparatus according to Embodiment 4;

FIG. 21 illustrates an example of a hardware configuration of a computer that implements the same functions as those of the detection apparatus;

FIG. 22 is a diagram for describing processing to specify a speech segment of a customer by using a related art;

FIG. 23 is a diagram for describing a problem of the related art.

### DESCRIPTION OF EMBODIMENT(S)

However, the above-described related art is unable to detect a speech segment of a specific speaker.

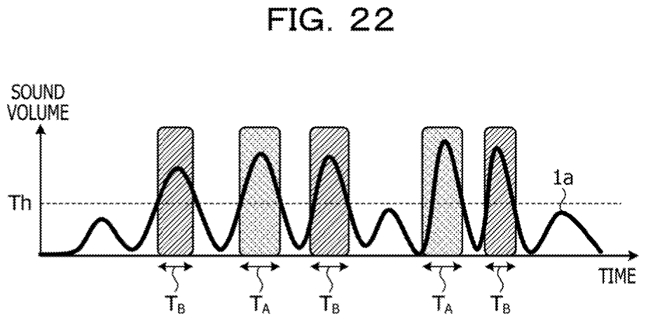

For example, it is possible to extract the voice information on the customer as described in FIG. 22 in the case where the microphone on the store clerk is located close to the customer. However, in usual face-to-face service, a distance between the store clerk and the customer may be unsteady or rather increased in many cases. As the distance between the store clerk and the customer is increased, more noise other than the voice of the customer is apt to be included in the voice information, which will complicate detection of the speech segment of the customer in conversation. Such noise other than the customer includes voices of surrounding people and the like.

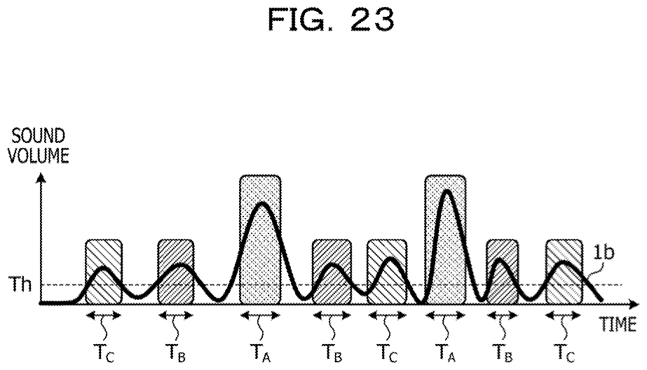

FIG. 23 is a diagram for describing a problem of the related art. The vertical axis in FIG. 23 is the axis corresponding to the sound volume (or the SNR) and the horizontal axis therein is the axis corresponding to the time. A line 1b indicates a relation between the sound volume and the time of the inputted voice. The microphone on the store clerk is assumed to be located far from the customer in the case of FIG. 23.

The voice of the store clerk is registered in advance and the speech segment T_{A} of the store clerk is specified based on the distribution of similarities of the inputted voice being the mixture of the voice of the store clerk and the voice of the customer to the registered voice. If the segment having the sound volume equal to or above the threshold Th is detected as the speech segment of the customer from the speech segments other than the speech segment T_{A} of the store clerk, a noise segment T_{C} will be included in the speech segment T_{B} of the customer. It is also difficult to distinguish between the speech segment T_{B} of the customer and the noise segment T_{C}.

According to an aspect of the embodiments, provided is a solution to detect a speech segment of a specific speaker.

Embodiments of a detection program, a detection method, and a detection apparatus disclosed in the present application will be described below in detail with reference to the drawings. Note that present invention is not limited to these embodiments.

### Embodiment 1

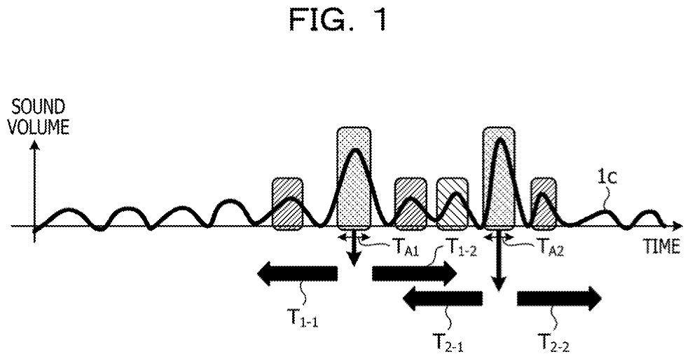

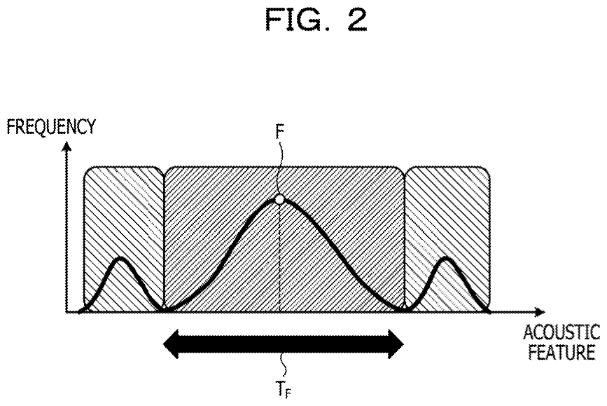

FIGS. 1 and 2 are diagrams for describing processing of a detection apparatus according to Embodiment 1. The detection apparatus according to Embodiment 1 may obtain acoustic features of a voice uttered from a first person (may be referred to as a “first speaker”) by performing a machine learning. In the following description, an acoustic feature learned using a voice uttered from the first speaker may be referred to as a “learned acoustic feature”. The detection apparatus acquires information on voices (hereinafter referred to as voice information) that contains a voice of the first speaker, a voice of a second speaker, and voices of a speaker other than the first and second speakers. For example, the first speaker corresponds to a store clerk and the second speaker corresponds to a customer. The voice information is information on the voices collected with a microphone which is put on the first speaker.

The vertical axis in FIG. 1 is the axis corresponding to a sound volume (or an SNR) and the horizontal axis therein is the axis corresponding to time. A line 1c indicates a relation between the sound volume and the time of the voice information. The detection apparatus detects first speech segments T_{A1} and T_{A2} of the first speaker included in the voice information based on the voice information and the learned acoustic feature. Although the illustration is omitted, reference sign S_{A1} denotes start time of the first speech segment T_{A1} and reference sign E_{A1} denotes end time thereof. Reference sign S_{A2} denotes start time of the first speech segment Tu and reference sign E_{A2} denotes end time thereof. In the following description, the first speech segments T_{A1} and T_{A2} will be collectively referred to as the first speech segments T_{A} when appropriate.

The detection apparatus sets up search ranges based on the first speech segments T_{A}. Each search range represents an example of a predetermined time range. Search ranges T₁₋₁, T₁₋₂, T₂₋₁, and T₂₋₂ are set up in the example illustrated in FIG. 1. The start time of the search range T₁₋₁ is defined as S_{A1}−D and the end time thereof is defined as S_{A1}. The start time of the search range T₁₋₂ is defined as E_{A1} and the end time thereof is defined as E_{A1}+D. The start time of the search range T₂₋₁ is defined as S_{A2}−D and the end time thereof is defined as S_{A2}. The start time of the search range T₂₋₂ is defined as E_{A2} and the end time thereof is defined as E_{A2}+D. The value D is an average time interval from the end time of the precedent first speech segment to the start time of the subsequent first speech segment.

The detection apparatus specifies each relation between an acoustic feature and a frequency regarding the voice information included in the search ranges T₁₋₁ and T₁₋₂. For example, the voice information included in the search ranges T₁₋₁ and T₁₋₂ is assumed to be divided into multiple frames and an acoustic feature is assumed to be calculated in terms of each frame. The segments of the multiple frames of the voice information included in the search ranges T₁₋₁ and T₁₋₂ are segments that are candidates for a second speech segment of the second speaker.

The vertical axis in FIG. 2 is the axis corresponding to the frequency and the horizontal axis therein is the axis corresponding to the acoustic feature. The acoustic feature corresponds to at least one of a pitch frequency, frame power, a formant frequency, and a voice arrival direction. The detection apparatus specifies a mode value F based on the relation between the acoustic feature and the frequency. The detection apparatus detects the range of the frame including the acoustic feature in a certain range T_{F} based on the mode value F as the second speech segment out of the multiple frames that are the candidates for the second speech segment.

The detection apparatus specifies each relation between the acoustic feature and the frequency regarding the voice information included in the search ranges T₂₋₁ and T₂₋₂, thus detecting the second speech segments.

As described above, the detection apparatus according to Embodiment 1 detects the first speech segments of the first speaker from the voice information on the multiple speakers based on the learned acoustic features of the first speaker, and detects the second speech segments of the second speaker based on the acoustic features in the search ranges included in certain ranges outside the first speech segments. This makes it possible to accurately detect the speech segments of the second speaker from the voice information containing the voices of the multiple speakers.

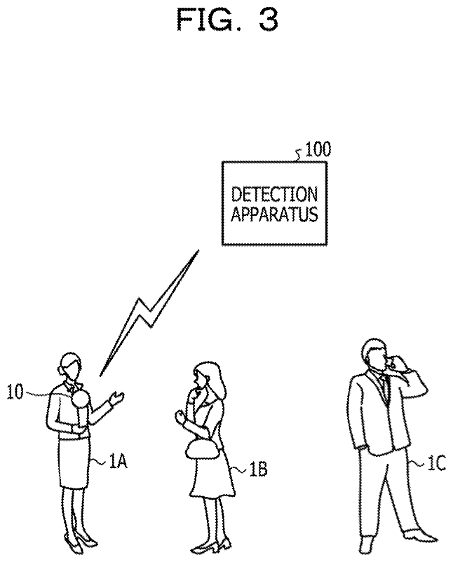

Next, a configuration of a system according to Embodiment 1 will be described. FIG. 3 illustrates the example of the system according to Embodiment 1. As illustrated in FIG. 3, this system includes a microphone terminal 10 and a detection apparatus 100. For example, the microphone terminal 10 and the detection apparatus 100 are wirelessly coupled to each other. The microphone terminal 10 may be coupled to the detection apparatus 100 by wire.

The microphone terminal 10 is put on a speaker 1A. The speaker 1A corresponds to a store clerk who serves a customer. The speaker 1A represents an example of the first speaker. A speaker 18 corresponds to the customer served by the speaker 1A. The speaker 16 represents an example of the second speaker. A speaker 1C not served by the speaker 1A is assumed to be present around the speakers 1A and 18.

The microphone terminal 10 is a device that collects voices. The microphone terminal 10 transmits the voice information to the detection apparatus 100. The voice information contains information on the voices of the speakers 1A to 1C. The microphone terminal 10 may include two or more microphones. When the microphone terminal 10 includes two or more microphones, the microphone terminal 10 transmits the voice information collected with the respective microphones to the detection apparatus 100.

The detection apparatus 100 acquires the voice information from the microphone terminal 10 and detects the speech segments of the speaker 1A from the voice information based on the learned acoustic feature of the speaker 1A. The detection apparatus 100 detects the speech segments of the speaker 1B based on the acoustic features of search ranges included in a certain range outside the detected speech segments of the speaker 1A.

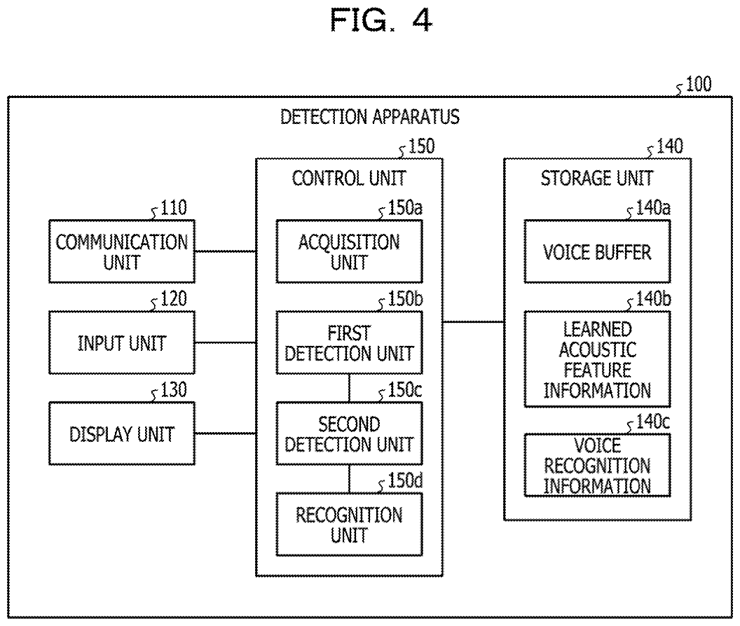

FIG. 4 is a functional block diagram illustrating a configuration of the detection apparatus according to Embodiment 1. As illustrated in FIG. 4, this detection apparatus 100 includes a communication unit 110, an input unit 120, a display unit 130, a storage unit 140, and a control unit 150.

The communication unit 110 is a processing unit that executes data communication wirelessly with the microphone terminal 10. The communication unit 110 is an example of a communication device. The communication unit 110 receives the voice information from the microphone terminal 10 and outputs the received voice information to the control unit 150. The detection apparatus 100 may be coupled to the microphone terminal 10 by wire. The detection apparatus 100 may be coupled to a network through the communication unit 110 and may transmit and receive data to and from an external apparatus (not illustrated).

The input unit 120 is an input device used to input a variety of information to the detection apparatus 100. The input unit 120 corresponds to a keyboard, a mouse, a touch panel, and the like.

The display unit 130 is a display device that displays information outputted from the control unit 150. The display unit 130 corresponds to a liquid crystal display, a touch panel, and the like.

The storage unit 140 includes a voice buffer 140a, learned acoustic feature information 140b, and voice recognition information 140c. The storage unit 140 corresponds to a semiconductor memory element such as a random-access memory (RAM) and a flash memory, or a storage device such as a hard disk drive (HDD).

The voice buffer 140a is a buffer that stores the voice information transmitted from the microphone terminal 10. In the voice information, a voice signal is associated with time.

The learned acoustic feature information 140b is information on the acoustic feature of the speaker 1A (the first speaker) learned in advance. Such acoustic features include the pitch frequency, the frame power, the formant frequency, and the voice arrival direction. For example, the learned acoustic feature information 140b is a vector that includes values of the pitch frequency, the frame power, the formant frequency, and the voice arrival direction, respectively, as its elements.

The voice recognition information 140c is information obtained by converting the voice information on the second speech segments of the speaker 16 into character strings.

The control unit 150 includes an acquisition unit 150a, a first detection unit 150b, a second detection unit 150c, and a recognition unit 150d. The control unit 150 is realized by any of a central processing unit (CPU), a microprocessor unit (MPU), a hardwired logic circuit such as an application-specific integrated circuit (ASIC) and a field-programmable gate array (FPGA), and the like.

The acquisition unit 150a is a processing unit that acquires the voice information from the microphone terminal 10 through the communication unit 110. The acquisition unit 150a sequentially stores pieces of the voice information in the voice buffer 140a.

The first detection unit 150b is a processing unit that acquires the voice information from the voice buffer 140a and detects the first speech segments of the speaker 1A (the first speaker) based on the learned acoustic feature information 140b. The first detection unit 150b executes voice segment detection processing, acoustic analysis processing, and similarity evaluation processing.

An example of the “voice segment detection processing” to be executed by the first detection unit 150b will be described to begin with. The first detection unit 150b specifies power of the voice information and detects a segment sandwiched between silent segments, in which the power falls below a threshold, as a voice segment. The first detection unit 150b may detect the voice segment by using the technique disclosed in international Publication Pamphlet No. WO 2009/145192.

The first detection unit 150b splits the voice information that is divided by the voice segments into fixed-length frames. The first detection unit 150b sets up frame numbers for identifying the respective frames. The first detection unit 150b executes the acoustic analysis processing and the similarity evaluation processing to be described later on each of the frames.

Next, an example of the “acoustic analysis processing” to be executed by the first detection unit 150b will be described. For example, the first detection unit 150b calculates the acoustic features based on the respective frames in the voice segments included in the voice information. The first detection unit 150b calculates the pitch frequency, the frame power, the formant frequency, and the voice arrival direction as the acoustic features, respectively.

An example of the processing to cause the first detection unit 150b to calculate the “pitch frequency” as the acoustic feature will be described. The first detection unit 150b calculates a pitch frequency p(n) of a voice signal included in a frame by using an estimation method according to a robust algorithm for pitch tracking (RAPT). Here, code n denotes the frame number. The first detection unit 150b may calculate the pitch frequency by using the technique disclosed in D. Talkin, “A Robust Algorithm for Pitch Tracking (RAPT)”, in Speech Coding & Synthesis, W. B. Kleijn and K. K. Pailwal (Eds.), Elsevier, pp. 495-518, 1995.

An example of the processing to cause the first detection unit 150b to calculate the “frame power” as the acoustic feature will be described. For instance, the first detection unit 150b calculates power S(n) of a frame having a predetermined length based on Formula (1). In Formula (1), code n denotes the frame number, code M denotes a time length of one frame (such as 20 ms), and code t denotes time. Meanwhile, code C(t) denotes the voice signal at the time t. The first detection unit 150b may calculate temporally smoothed power as the frame power while using a predetermined smoothing coefficient.

$$S ( n ) = 10 {log}_{10} ( {\sum }_{t = n * M}^{( n + 1 ) * M - 1} {C ( t )}^{2} ) \qquad ( 1 )$$

An example of the processing to cause the first detection unit 150b to calculate the “formant frequency” as the acoustic feature will be described. The first detection unit 150b performs a linear prediction coding analysis on the voice signal C(t) included in the frame, and calculates multiple formant frequencies by extracting multiple peaks therefrom. For example, the first detection unit 150b calculates a first formant frequency F1, a second formant frequency F2, and a third formant frequency F3 in ascending order of frequency. The first detection unit 150b may calculate the formant frequencies by using the technique disclosed in Japanese Laid-open Patent Publication No. 62-54297.

An example of the processing to cause the first detection unit 150b to calculate the “voice arrival direction” as the acoustic feature will be described. The first detection unit 150b calculates the voice arrival direction based on a phase difference between pieces of the voice information collected with two microphones.

In this case, the first detection unit 150b detects the voice segments from the respective pieces of the voice information collected with the microphones of the microphone terminal 10, and calculates the phase difference by comparing the pieces of the voice information corresponding to the same time frame in the respective voice segments. The first detection unit 150b may calculate the voice arrival direction by using the technique disclosed in Japanese Laid-open Patent Publication No. 2008-175733.

The first detection unit 150b calculates the acoustic features of the respective frames included in the voice segments of the voice information by executing the above-described acoustic analysis processing. The first detection unit 150b may use at least one of the pitch frequency, the frame power, the formant frequency, and the voice arrival direction as the acoustic feature or use a combination of these factors collectively as the acoustic feature. In the following description, the acoustic feature of each frame included in the voice segment of the voice information will be referred to as an “evaluation target acoustic feature”.

Next, an example of the “similarity evaluation processing” to be executed by the first detection unit 150b will be described. The first detection unit 150b calculates a similarity of the evaluation target acoustic feature in each frame of the voice segment to the learned acoustic feature information 140b.

For example, the first detection unit 150b may calculate a Pearson's correlation coefficient as the similarity or calculate the similarity by using a Eudidean distance.

A description will be given of a case where the first detection unit 150b calculates the Pearson's correlation coefficient as the similarity. The Pearson's correlation coefficient cor is calculated by Formula 2. In Formula 2, code X is a vector that includes the values of the pitch frequency, the frame power, the formant frequency, and the voice arrival direction of the acoustic features of the speaker 1A (the first speaker) included in the learned acoustic feature information 140b, respectively, as its elements. Meanwhile, code Y is a vector that includes the values of the pitch frequency, the frame power, the formant frequency, and the voice arrival direction of the evaluation target acoustic feature, respectively, as its elements. Code i denotes the number indicating the element of the vector. The first detection unit 150b specifies the frame of the evaluation target acoustic feature with which the Pearson's correlation coefficient cor becomes equal to or above a threshold Thc as the frame including the voice of the speaker 1A. The threshold Thc is set to 0.7, for example. The threshold Thc may be changed as appropriate.

$$cor = \frac{{\sum }_{i = 1}^{n} ( {X}_{i} - \overline{X} ) ( {Y}_{i} - \overline{Y} )}{\sqrt{{\sum }_{i = 1}^{n} {( {X}_{i} - \overline{X} )}^{2} \sqrt{{\sum }_{i = 1}^{n} {( {Y}_{i} - \overline{Y} )}^{2}}}} \qquad ( 2 )$$

A description will be given of a case where the first detection unit 150b calculates the similarity by using the Eudidean distance. The Eudidean distance d is calculated by Formula (3) and the similarity R is calculated by Formula (4). In Formula (3), codes a₁ to aᵢ correspond to the values of the pitch frequency, the frame power, the formant frequency, and the voice arrival direction of the acoustic features of the speaker 1A (the first speaker) included in the learned acoustic feature information 140b. Codes b₁ to bᵢ correspond to the values of the pitch frequency, the frame power, the formant frequency, and the voice arrival direction of the evaluation target acoustic features. The first detection unit 150b specifies the frame of the evaluation target acoustic feature with which the similarity R becomes equal to or above a threshold Thr as the frame including the voice of the speaker 1A. The threshold Thr is set to 0.7, for example. The threshold Thr may be changed as appropriate.

$$\begin{matrix}d = \sqrt{{( {a}_{1} - {b}_{1} )}^{2} + {( {a}_{2} - {b}_{2} )}^{2} + … + {( {a}_{i} - {b}_{i} )}^{2}} & ( 3 ) \\ R = 1 / ( 1 + d ) & ( 4 )\end{matrix}$$

The first detection unit 150b specifies the frame of the evaluation target acoustic feature with which the similarity becomes equal to or above the threshold as the frame including the voice of the speaker 1A (the first speaker). The first detection unit 150b detects a series of frame segments including the voices of the speaker 1A as the first speech segments.

The first detection unit 150b repeatedly executes the above-described processing and outputs information on the first speech segment to the second detection unit 150c every time the first detection unit 150b detects the first speech segment. The information on the i-th first speech segment includes start time Sᵢ of the i-th first speech segment and end time 15 of the i-th first speech segment.

The first detection unit 150b outputs the information, in which the respective frames included in the voice segments are associated with the evaluation target acoustic features, to the second detection unit 150c.

The second detection unit 150c is a processing unit that detects the second speech segments of the speaker 16 (the second speaker) among the multiple speakers based on the information on the first speech segments and based on the acoustic features of the voice information included in predetermined time ranges outside the first speech segments. For example, the second detection unit 150c executes average speech segment calculation processing, search range setting processing, distribution calculation processing, and second speech segment detection processing.

The “average speech segment calculation processing” to be executed by the second detection unit 150c will be described to begin with. For example, the second detection unit 150c acquires the information on the multiple first speech segments and calculates an average time interval D from the preceding first speech segment to the following first speech segment based on Formula (5). In Formula (5), code Sᵢ denotes start time of the i-th first speech segment. Code Eᵢ denotes end time of the i-th first speech segment.

$$D = \frac{1}{n - 1} {\sum }_{i = 1}^{n} ( {S}_{i} - {E}_{i - 1} ) \qquad ( 5 )$$

Next, the “search range setting processing” to be executed by the second detection unit 150c will be described. The second detection unit 150c sets search ranges Tᵢ₋₁ and Tᵢ₋₂ regarding the i-th first speech segment. The start time of the search range Tᵢ₋₁ is defined as Sᵢ−D and the end time thereof is defined as Sᵢ. The start time of the search range Tᵢ₋₂ is defined as Eᵢ and the end time thereof is defined as Eᵢ+D.

The second detection unit 150c may calculate segment lengths of the first speech segments and correct the time interval D depending on a result of comparison between an average value of the segment lengths and the actual segment lengths. The second detection unit 150c calculates a segment length 4 of the i-th first speech segment by using Formula (6). The second detection unit 150c calculates the average value of the segment lengths by using Formula (7).

$$\begin{matrix}{L}_{i} = {E}_{i} - {S}_{i} & ( 6 ) \\ \overline{L} = \frac{1}{n - 1} {\sum }_{i = 0}^{n} ( {E}_{i} - {S}_{i} ) & ( 7 )\end{matrix}$$

When the segment length L is smaller than the average value of the segment lengths, the second detection unit 150c sets the search ranges Tᵢ₋₁ and Tᵢ₋₂ while using a value D1 obtained by multiplying the time interval D by a correction factor α₁. The start time of the search range Tᵢ₋₁ is defined as Sᵢ−D1 and the end time thereof is defined as Sᵢ. The start time of the search range Tᵢ₋₂ is defined as Eᵢ and the end time thereof is defined as Eᵢ+D1. The range of the correction factor α₁ is defined as 1<α₁<2.

When the segment length U is smaller than the average value of the segment lengths, the speaker 1A is presumably chiming in with the speech of the speaker 1B. For this reason, it is highly likely that the speaker 18 is speaking longer than usual and the second detection unit 150c therefore sets the search range larger than usual.

When the segment length U is larger than the average value of the segment lengths, the second detection unit 150c sets the search ranges Tᵢ₋₁ and Tᵢ₋₂ while using a value D2 obtained by multiplying the time interval D by a correction factor α₂. The start time of the search range Tᵢ₋₁ is defined as Sᵢ−D2 and the end time thereof is defined as Sᵢ. The start time of the search range Tᵢ₋₂ is defined as Eᵢ and the end time thereof is defined as Eᵢ+D2. The range of the correction factor α2 is defined as 0<α₂<1.

When the segment length 1 is larger than the average value of the segment lengths, the speaker 1B is presumably chiming in with the speech of the speaker 1A. For this reason, it is highly likely that the speaker 1B is speaking shorter than usual and the second detection unit 150c therefore sets the search range smaller than usual.

Next, the “distribution calculation processing” to be executed by the second detection unit 150c will be described. The second detection unit 150c aggregates the evaluation target acoustic features of the multiple frames included in the search ranges set in the search range setting processing, and generates acoustic feature distribution for each search range.

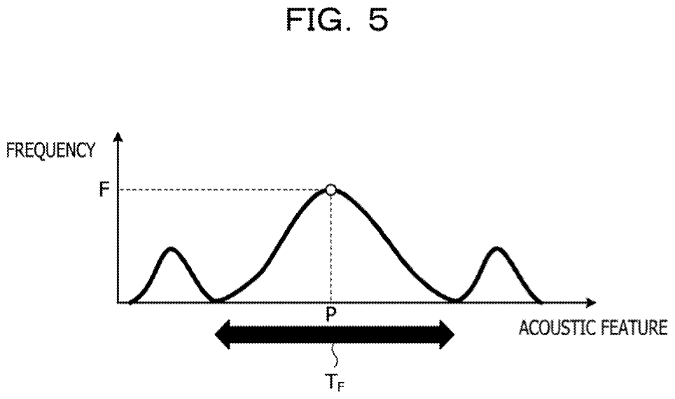

FIG. 5 illustrates an example of acoustic feature distribution. The vertical axis in FIG. 5 is the axis corresponding to the frequency and the horizontal axis therein is the axis corresponding to the acoustic feature. The second detection unit 150c specifies a mode position P of the acoustic feature corresponding to the mode value F based on the relation between the acoustic feature and the frequency. The second detection unit 150c specifies the frame having the acoustic feature in a certain range T_{F} including the mode position P as the frame including the voice of the speaker 1B.

The second detection unit 150c repeatedly executes the above-described processing for each of the search ranges and specifies the multiple frames each including the voice of the speaker 1B.

Next, the “second speech segment detection processing” to be executed by the second detection unit 150c will be described. The second detection unit 150c detects a series of frame segments including the voices of the speaker 1B, which are detected from each of the search ranges, as the second speech segments. The second detection unit 150c outputs information on the second speech segments included in the respective search ranges to the recognition unit 150d. The information on each second speech segment includes start time of the second speech segment and end time of the second speech segment.

The recognition unit 150d is a processing unit that acquires the voice information included in the second speech segments from the voice buffer 140a, executes the voice recognition, and converts the voice information into character strings. When the recognition unit 150d converts the voice information into the character strings, the recognition unit 150d may also calculate reliability in parallel. The recognition unit 150d registers information on the converted character strings and information on the reliability with the voice recognition information 140c.

The recognition unit 150d may use any kind of technique for converting the voice information into the character strings. For example, the recognition unit 150d converts the voice information into the character strings by using the technique disclosed in Japanese Laid-open Patent Publication No. 4-255900.

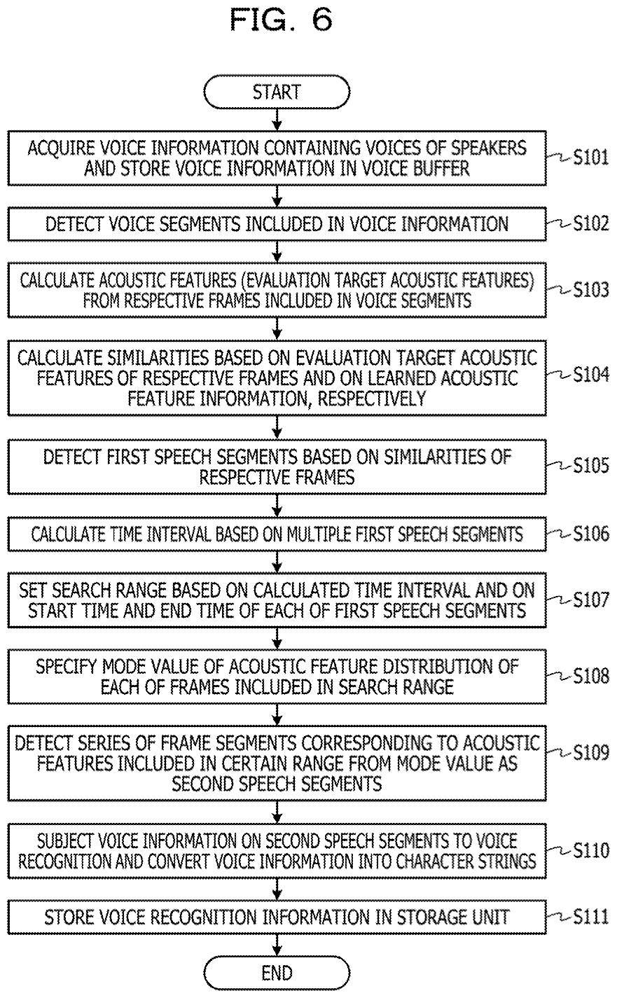

Next an example of processing procedures of the detection apparatus 100 according to Embodiment 1 will be described. FIG. 6 is a flowchart illustrating the processing procedures of the detection apparatus according to Embodiment 1. As illustrated in FIG. 6, the acquisition unit 150a of the detection apparatus 100 acquires the voice information containing the voices of the multiple speakers and stores the information in the voice buffer 140a (step S101).

The first detection unit 150b of the detection apparatus 100 detects the voice segments included in the voice information (step S102). The first detection unit 150b calculates the acoustic features (the evaluation target acoustic features) from the respective frames included in the voice segments (step S103).

The first detection unit 150b calculates the similarities based on the evaluation target acoustic features of the respective frames and on the learned acoustic feature information 140b, respectively (step S104). The first detection unit 150b detects the first speech segments based on the similarities of the respective frames (step S105).

The second detection unit 150c of the detection apparatus 100 calculates the time interval based on the multiple first speech segments (step S106). The second detection unit 150c sets the search range based on the calculated time interval and on the start time and the end time of each of the first speech segments (step S107).

The second detection unit 150c specifies the mode value of the acoustic feature distribution of each of the frames included in the search range (step S108). The second detection unit 150c detects the series of frame segments corresponding to the acoustic features included in a certain range from the mode value as the second speech segments (step S109).

The recognition unit 150d of the detection apparatus 100 subjects the voice information on the second speech segments to the voice recognition and converts the voice information into the character strings (step S110). The recognition unit 150d stores the voice recognition information 140c representing a result of voice recognition in the storage unit 140 (step S111).

Next, effects of the detection apparatus 100 according to Embodiment 1 will be described. The detection apparatus 100 detects the first speech segments of the first speaker from the voice information on the multiple speakers based on the learned acoustic features of the first speaker, and detects the second speech segments of the second speaker based on the acoustic features in the search ranges outside the first speech segments. This makes it possible to accurately detect the speech segments of the second speaker from the voice information containing the voices of the multiple speakers.

The detection apparatus 100 calculates the similarities of the learned acoustic feature information 140b to the evaluation target acoustic features of the respective frames in the voice segments, and detects the segments of the series of frame segments having the similarities equal to or above the threshold as the first speech segments. In this way, it is possible to detect the speech segments of the speaker 1A who speaks the voices having the acoustic feature learned in advance.

The detection apparatus 100 calculates the average value of the time intervals each ranging from the point of detection of the precedent first speech segment to the point of detection of the subsequent first speech segment, and sets the search range based on the calculated average value. This makes it possible to appropriately set the range including the voice information on the target speaker.

The detection apparatus 100 calculates the average value of the multiple first speech segments in advance. The detection apparatus 100 increases the search range when a certain first second speech segment is smaller than the average value, or reduces the search range when a certain second speech segment is larger than the average value. This makes it possible to appropriately set the range including the voice information on the target speaker.

When the first speech segment is smaller than the average value of the segment lengths, the speaker 1A is presumably chiming in with the speech of the target speaker 1B. For this reason, as it is highly likely that the speaker 16 is speaking longer than usual, the detection apparatus 100 may keep the voice information on the speaker 18 from falling out of the search range by increasing the search range more than usual.

When the first speech segment is larger than the average value of the segment lengths, the speaker 1B is presumably chiming in with the speech of the target speaker 1A. For this reason, as it is highly likely that the speaker 1 is speaking shorter than usual, the detection apparatus 100 may keep a range where it is less likely to include the voice information on the speaker 1B from being included in the search range by reducing the search range more than usual.

The detection apparatus 100 specifies the mode values of the evaluation target acoustic features of the multiple frames included in the search range, and detects the segment including the frame close to the mode value as the second speech segment. This makes it possible to efficiently exclude noise attributed to voices of surrounding people (such as the speaker 1C) other than the target speaker 1B.

### Embodiment 2

Next, a detection apparatus according to Embodiment 2 will be described. A system according to Embodiment 2 is assumed to be wirelessly coupled to the microphone terminal 10 as with the system of Embodiment 1 described with reference to FIG. 3. The microphone terminal 10 is put on the speaker 1A in Embodiment 2 as well. The speaker 1A corresponds to a store clerk who serves a customer. A speaker 1B corresponds to the customer served by the speaker 1A. A speaker 1C not served by the speaker 1A is assumed to be present around the speakers 1A and 1B.

When the detection apparatus according to Embodiment 2 acquires the voice information from the microphone terminal 10, the detection apparatus detects the first speech segments of the first speaker based on the learned acoustic feature. The detection apparatus updates the learned acoustic feature based on the acoustic feature included in the first speech segment every time the detection apparatus detects the first speech segment.

The detection apparatus according to Embodiment 2 executes the following processing when the detection apparatus detects the second speech segments based on the acoustic features in the search range. The detection apparatus calculates the mode value of the similarity of the evaluation target acoustic feature of each frame in the search range to the learned acoustic feature, and detects the second speech segment based on a threshold corresponding to the calculated mode value.

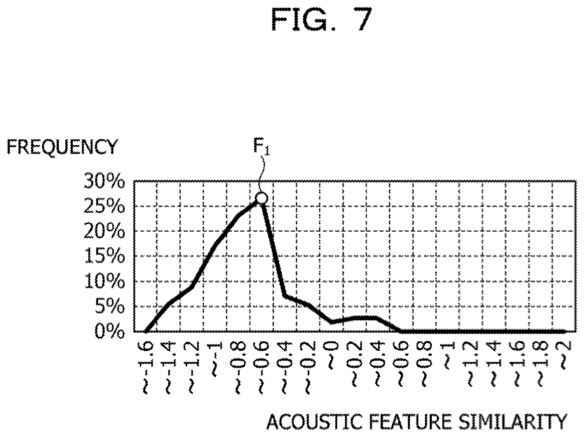

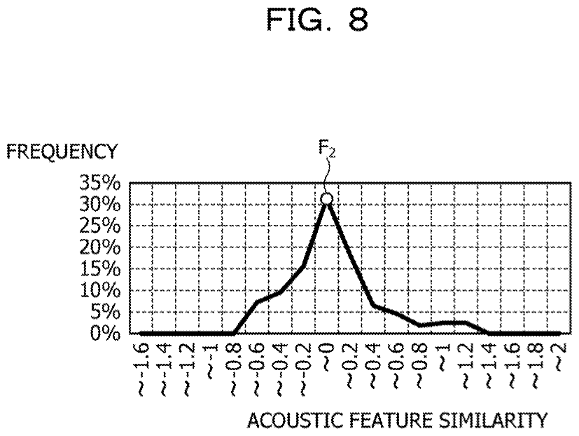

FIGS. 7 to 9 are diagrams for describing processing of the detection apparatus according to Embodiment 2. The vertical axis in each of FIGS. 7 and 8 is the axis corresponding to the frequency. The horizontal axis therein is the axis corresponding to the similarity of the learned acoustic feature to the evaluation target acoustic feature. In the following description, the similarity of the learned acoustic feature to the evaluation target acoustic feature will be expressed as an “acoustic feature similarity” as appropriate.

For example, FIG. 7 illustrates the relation between the frequency and the acoustic feature similarity when the voice of the target speaker 18 is loud, in which the mode value of the similarity turns out to be F₁. The case where the voice of the target speaker 1B is loud means that many acoustic features unique to the voice of the speaker 18 are remaining.

On the other hand, FIG. 8 illustrates the relation between the frequency and the acoustic feature similarity when the voice of the speaker 16 is low, in which the mode value of the similarity turns out to be F₂. When the voice of the target speaker 18 is low, the voice of the speaker 1 is likely to vanish into background noise (such as the voice of the speaker 1C) and the acoustic features unique to the speaker 1B are partially lost.

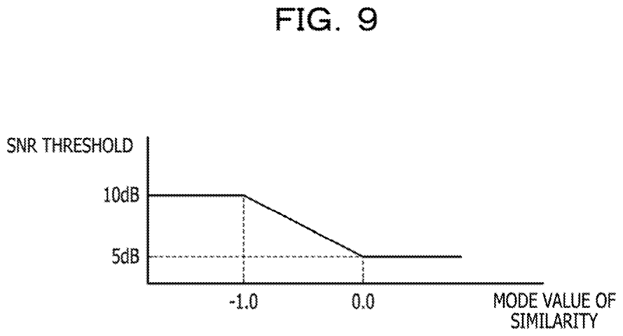

FIG. 9 illustrates a relation between the mode value of the similarity and an SNR threshold. The vertical axis in FIG. 9 is the axis corresponding to the SNR threshold and the horizontal axis therein is the axis corresponding to the mode value of the similarity. As illustrated in FIG. 9, the SNR threshold becomes smaller as the mode value of the similarity grows larger.

For example, as described with reference to FIG. 7, the mode value F₁ of the similarity becomes small when the voice of the target speaker 1B is loud. The detection apparatus sets a relatively large SNR threshold, and detects a segment of a frame having the SNR equal to or above the relatively large SNR threshold among the respective frames in the search range as the second speech segment.

As described with reference to FIG. 8, the mode value F₂ of the similarity becomes small when the voice of the target speaker 1B is low. The detection apparatus sets a relatively small SNR threshold, and detects a segment of a frame having the SNR equal to or above the relatively small SNR threshold among the respective frames in the search range as the second speech segment.

As described above, the detection apparatus according to Embodiment 2 updates the learned acoustic feature based on the acoustic feature included in the first speech segment every time the detection apparatus detects the first speech segment. Thus, it is possible to keep the learned acoustic features up to date and to improve detection accuracy of the first speech segments.

The detection apparatus calculates the mode value of the similarity of the evaluation target acoustic feature of each frame in the search range to the learned acoustic feature, and detects the second speech segment based on the SNR threshold corresponding to the calculated mode value. Thus, it is possible to set the optimum SNR threshold regarding the loudness of the voice of the target second speaker, and to improve detection accuracy of the second speech segments.

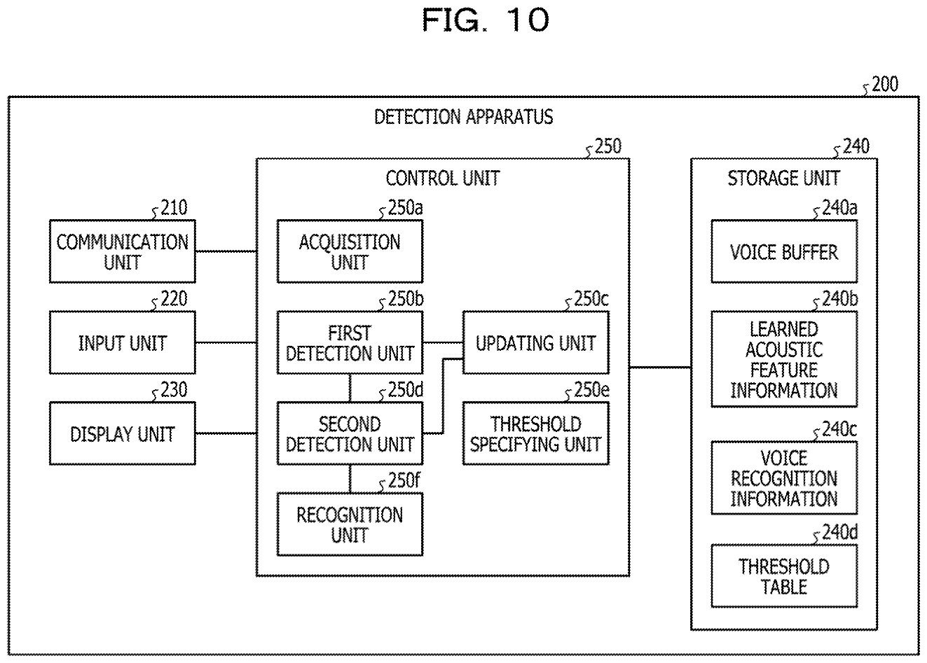

FIG. 10 is a functional block diagram illustrating a configuration of the detection apparatus according to Embodiment 2. As illustrated in FIG. 10, this detection apparatus 200 includes a communication unit 210, an input unit 220, a display unit 230, a storage unit 240, and a control unit 250.

The communication unit 210 is a processing unit that executes data communication wirelessly with the microphone terminal 10. The communication unit 210 is an example of the communication device. The communication unit 210 receives the voice information from the microphone terminal 10 and outputs the received voice information to the control unit 250. The detection apparatus 200 may be coupled to the microphone terminal 10 by wire. The detection apparatus 200 may be coupled to a network through the communication unit 210 and may transmit and receive data to and from an external apparatus (not illustrated).

The input unit 220 is an input device used to input a variety of information to the detection apparatus 200. The input unit 220 corresponds to a keyboard, a mouse, a touch panel, and the like.

The display unit 230 is a display device that displays information outputted from the control unit 250. The display unit 230 corresponds to a liquid crystal display, a touch panel, and the like.

The storage unit 240 includes a voice buffer 240a, learned acoustic feature information 240b, voice recognition information 240c, and a threshold table 240d. The storage unit 240 corresponds to a semiconductor memory element such as a RAM and a flash memory, or a storage device such as an HDD.

The voice buffer 240a is a buffer that stores the voice information transmitted from the microphone terminal 10. In the voice information, a voice signal is associated with time.

The learned acoustic feature information 240b is information on the acoustic feature of the speaker 1A (the first speaker) learned in advance. Such acoustic features include the pitch frequency, the frame power, the formant frequency, and the voice arrival direction, SNR, or the like. For example, the learned acoustic feature information 240b is a vector that includes the values of the pitch frequency, the frame power, the formant frequency, and the voice arrival direction, respectively, as its elements.

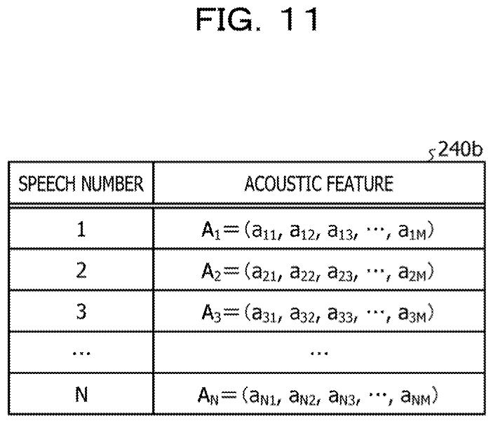

FIG. 11 illustrates an example of a data structure of the learned acoustic feature information according to Embodiment 2. As illustrated in FIG. 11, the learned acoustic feature information 240b associates a speech number with the acoustic feature. The speech number is a number to identify the acoustic feature in the first speech segment spoken by the speaker 1A. The acoustic feature represents the acoustic feature in the first speech segment.

The voice recognition information 240c is information obtained by converting the voice information on the second speech segments of the speaker 1B into the character strings.

The threshold table 240d is a table that defines the relation between the acoustic feature similarity and the SNR threshold. The relation between the acoustic feature similarity and the SNR threshold defined in the threshold table 240d corresponds to the graph illustrated in FIG. 9.

The control unit 250 includes an acquisition unit 250a, a first detection unit 250b, an updating unit 250c, a second detection unit 250d, and a recognition unit 250e. The control unit 250 is realized by any of a CPU, an MPU, a hardwired logic circuit such as an ASIC and an FPGA, and the like.

The acquisition unit 250a is a processing unit that acquires the voice information from the microphone terminal 10 through the communication unit 210. The acquisition unit 250a sequentially stores pieces of the voice information in the voice buffer 240a.

The first detection unit 250b is a processing unit that acquires the voice information from the voice buffer 240a and detects the first speech segments of the speaker 1A (the first speaker) based on the learned acoustic feature information 240b. The first detection unit 250b executes the voice segment detection processing, the acoustic analysis processing, and the similarity evaluation processing. The voice segment detection processing and the similarity evaluation processing to be executed by the first detection unit 250b is the same as the processing of the first detection unit 150b described in Embodiment 1.

The first detection unit 250b calculates the pitch frequency, the frame power, the formant frequency, the voice arrival direction, and the SNR as the acoustic features. The processing to cause the first detection unit 250b to calculate the pitch frequency, the frame power, the formant frequency, and the voice arrival direction is the same as the processing of the first detection unit 150b described in Embodiment 1.

An example of the processing to cause the first detection unit 250b to calculate the “SNR” as the acoustic feature will be described. The first detection unit 250b divides the inputted voice information into multiple frames and calculates power S(n) for each of the frames. The first detection unit 250b calculates the power S(n) based on Formula (1). The first detection unit 250b determines the existence of a speech segment based on the power S(n).

When the power S(n) is larger than a threshold TH1, the first detection unit 250b determines that the frame of the frame number n includes the speech and sets v(n)=1. On the other hand, when the power S(n) is equal to or below the threshold TH1, the first detection unit 250b determines that the frame of the frame number n does not include a speech and sets v(n)=0.

The first detection unit 250b updates a noise level N depending on a determination result v1(n) of the speech segment. When v(n)=1 holds true, the first detection unit 250b updates the noise level N(n) based on Formula (8). On the other hand, when v(n)=0 holds true, the first detection unit 250b updates the noise level N(n) based on Formula (9). Note that code “coef” in the following Formula (8) denotes a forgetting coefficient which adopts a value of 0.9, for example.

N(n)=N(n−1)*coef+S(n)*(1−coef) (8)

N(n)=N(n−1) (9)

The first detection unit 250b calculates the SNR(n) based on Formula (10).

SNR(n)=S(n)−N(n) (10)

The first detection unit 250b outputs the detected information on the first speech segments to the updating unit 250c and the second detection unit 250d. The information on the i-th first speech segment includes the start time Sᵢ of the i-th first speech segment and the end time Eᵢ of the i-th first speech segment.

The first detection unit 250b outputs the information, in which the respective frames included in the first speech segments are associated with the evaluation target acoustic features, to the updating unit 250c. The first detection unit 250b outputs the information, in which the respective frames included in the voice segments are associated with the evaluation target acoustic features, to the second detection unit 250d.

The updating unit 250c is a processing unit that updates the learned acoustic feature information 240b based on the evaluation target acoustic features of the respective frames included in the first speech segments. The updating unit 250c calculates a representative value of the evaluation target acoustic features of the respective frames included in the first speech segments. For example, the updating unit 250c calculates either an average value or a median value of the evaluation target acoustic features of the respective frames included in the first speech segments as the representative value of the first speech segments.

When the number of respective records in the learned acoustic feature information 240b falls below N pieces, the updating unit 250c registers the representative value of the first speech segments with the learned acoustic feature information 240b. When the number of the records falls below N pieces, the updating unit 250c repeats the above-described processing every time the evaluation target acoustic feature of each frame included in the first speech segment is acquired from the first detection unit 250b, and registers the representative values (the acoustic features) of the first speech segments in order from the beginning.

When the number of the respective records in the learned acoustic feature information 240b is equal to or above N pieces, the updating unit 250c deletes the record on the top in the learned acoustic feature information 240b and registers the new representative value (the acoustic feature) of the first speech segments at the tail end of the learned acoustic feature information 240b. By executing the above-described processing, the updating unit 250c maintains N pieces of the respective records in the learned acoustic feature information 240b.

When the learned acoustic feature information 240b is updated, the updating unit 250c calculates a learning value of the learned acoustic feature information 240b based on Formula (11). The updating unit 250c outputs the learning value of the learned acoustic feature to the second detection unit 250d. Code Aₜ included in Formula (11) denotes the acoustic feature of a speech number t. Code M denotes the number of dimensions (the number of elements) of the acoustic feature. The value of N is set to 50.

$$\overline{A} = \frac{1}{N} {\sum }_{t = 0}^{N} {A}_{t} \qquad ( 11 )$$

The second detection unit 250d is a processing unit that detects the second speech segments of the speaker 1B (the second speaker) among the multiple speakers based on the information on the first speech segments and based on the acoustic features of the voice information included in predetermined time ranges outside the first speech segments. For example, the second detection unit 250d executes the average speech segment calculation processing, the search range setting processing, the distribution calculation processing, and the second speech segment detection processing.

The average speech segment calculation processing and the search range setting processing to be executed by the second detection unit 250d is the same as the processing of the second detection unit 150c described in Embodiment 1.

The “distribution calculation processing” to be executed by the 15 second detection unit 250d will be described. The second detection unit 250d calculates the similarities of the evaluation target acoustic features of the multiple frames included in the search ranges set in the search range setting processing to the learning values (the learned acoustic features) acquired from the updating unit 250c. For example, the second detection unit 250d may calculate a Pearson's correlation coefficient as the similarity or calculate the similarity by using a Eudidean distance.

The second detection unit 250d specifies the mode value of the distribution from the distribution of similarities of the evaluation target acoustic features of the multiple frames included in the search ranges to the learning values (the learned acoustic features) acquired from the updating unit 250c. For example, the mode value turns out to be the mode value F₁ when the distribution of similarities of the acoustic features takes on the distribution depicted in FIG. 7. The mode value turns out to be the mode value F₂ when the distribution of similarities of the acoustic features takes on the distribution depicted in FIG. 8.

The second detection unit 250d compares the specified mode value with the threshold table 240d and specifies the SNR threshold corresponding to the mode value.

Next, the “second speech segment detection processing” to be executed by the second detection unit 250d will be described. The second detection unit 250d compares the SNR of each of the frames included in the search range with the SNR threshold, and detects the segments of the frames having the SNR equal to or above the SNR threshold as the second speech segments. The second detection unit 250d outputs information on the second speech segments included in the respective search ranges to the recognition unit 250e. The information on each second speech segment includes the start time of the second speech segment and the end time E of the second speech segment.

The recognition unit 250e is a processing unit that acquires the voice information included in the second speech segments from the voice buffer 240a, executes the voice recognition, and converts the voice information into character strings. When the recognition unit 250e converts the voice information into the character strings, the recognition unit 250e may also calculate the reliability in parallel. The recognition unit 250e registers the information on the converted character strings and the information on the reliability with the voice recognition information 240c.

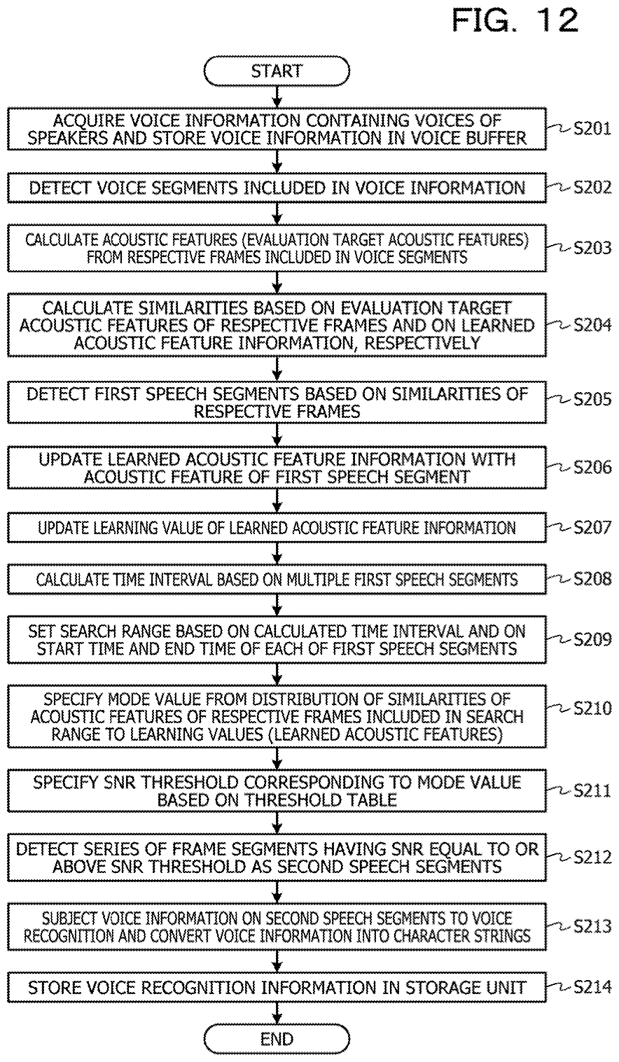

Next, an example of processing procedures of the detection apparatus 200 according to Embodiment 2 will be described. FIG. 12 is a flowchart illustrating the processing procedures of the detection apparatus according to Embodiment 2. As illustrated in FIG. 12, the acquisition unit 250a of the detection apparatus 200 acquires the voice information containing the voices of the multiple speakers and stores the information in the voice buffer 240a (step S201).

The first detection unit 250b of the detection apparatus 200 detects the voice segments included in the voice information (step S202). The first detection unit 250b calculates the acoustic features (the evaluation target acoustic features) from the respective frames included in the voice segments (step S203).

The first detection unit 250b calculates the similarities based on the evaluation target acoustic features of the respective frames and on the learned acoustic feature information 240b, respectively (step S204). The first detection unit 250b detects the first speech segments based on the similarities of the respective frames (step S205).

The updating unit 250c of the detection apparatus 200 updates the learned acoustic feature information 240b with the acoustic features of the first speech segments (step S206). The updating unit 250c updates the learning value of the learned acoustic feature information 240b (step S207).

The second detection unit 250d calculates the time interval based on the multiple first speech segments (step S208). The second detection unit 250d determines the search range based on the calculated time interval and on the start time and the end time of each of the first speech segments (step S209).

The second detection unit 250d specifies the mode value from the distribution of similarities of the acoustic features of the respective frames included in the search range to the learning values (the learned acoustic features) (step S210). The second detection unit 250d specifies the SNR threshold corresponding to the mode value based on the threshold table 240d (step S211).

The second detection unit 250d detects the series of frame segments having the SNR equal to or above the SNR threshold as the second speech segments (step S212). The recognition unit 250e of the detection apparatus 200 subjects the voice information on the second speech segments to the voice recognition and converts the voice information into the character strings (step S213). The recognition unit 250e stores the voice recognition information 240c representing the result of voice recognition in the storage unit 240 (step S214).

Next, effects of the detection apparatus 200 according to Embodiment 2 will be described. The detection apparatus 200 updates the learned acoustic feature information 240b based on the acoustic feature included in the first speech segment every time the detection apparatus 200 detects the first speech segment by using the learned acoustic feature information 240b. Thus, it is possible to keep the learned acoustic features up to date and to improve detection accuracy of the first speech segments.

The detection apparatus 200 calculates the mode value of the similarity of the evaluation target acoustic feature of each frame in the search range to the learned acoustic feature, and detects the second speech segment based on the SNR threshold corresponding to the calculated mode value. Thus, it is possible to set the optimum SNR threshold regarding the loudness of the voice of the target second speaker, and to improve detection accuracy of the second speech segments.

Note that although the detection apparatus 200 according to Embodiment 2 specifies the SNR threshold based on the threshold table 240d after the specification of the mode value and detects the second speech segment by using the SNR threshold, the configuration of the detection apparatus 200 is not limited only to the foregoing.

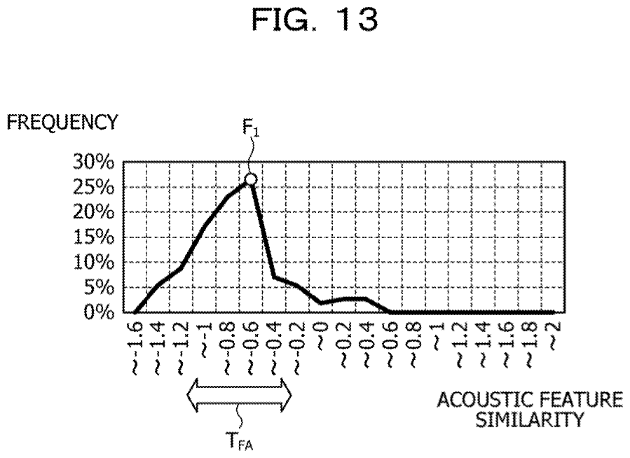

FIG. 13 is a diagram for describing other processing of the detection apparatus. The second detection unit 250d of the detection apparatus 200 specifies the mode value F₁ of the distribution from the distribution of similarities of the evaluation target acoustic features of the multiple frames included in the search ranges to the learning values (the learned acoustic features) acquired from the updating unit 250c.

The second detection unit 250d sets a range T_{FA} based on the mode value F₁. The second detection unit 250d detects the series of frame segments among the multiple frames included in the search range, with the similarities of the acoustic features therein being included in the range T_{FA}, as the second speech segments. As the second detection unit 250d executes the above-described processing, it is possible to accurately detect the second speech segments of the speaker 16 without using the threshold table 240d.

### Embodiment 3

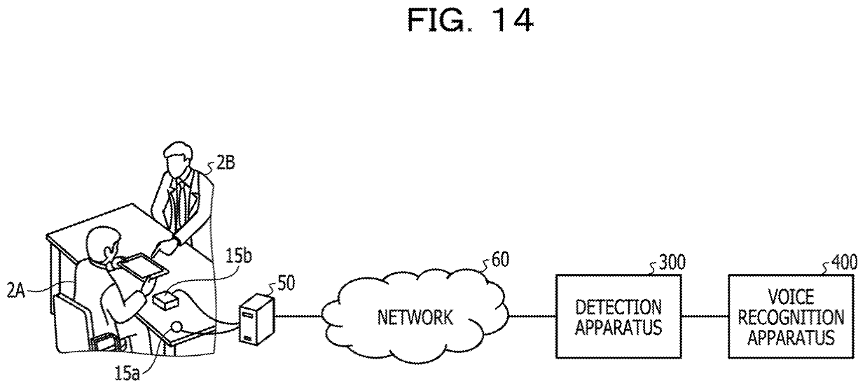

Next, a configuration of a system according to Embodiment 3 will be described. FIG. 14 illustrates an example of the system according to Embodiment 3. As illustrated in FIG. 14, this system includes a microphone terminal 15a, a camera 15b, a relay apparatus 50, a detection apparatus 300, and a voice recognition apparatus 400.

The microphone terminal 15a and the camera 15b are coupled to the relay apparatus 50. The relay apparatus 50 is coupled to the detection apparatus 300 through a network 60. The detection apparatus 300 is coupled to the voice recognition apparatus 400. A speaker 2A is assumed to be serving a speaker 2B near the microphone terminal 15a. The speaker 2A is assumed to be a store clerk and the speaker 2B is assumed to be a customer, for example. The speaker 2A represents an example of the first speaker. The speaker 2B represents an example of the second speaker. Other speakers (not illustrated) may be present around the speakers 2A and 2B.

The microphone terminal 15a is a device that collects voices. The microphone terminal 15a outputs the voice information to the relay apparatus 50. The voice information contains information on the voices of the speakers 2A and 2B and other speakers. The microphone terminal 15a may include two or more microphones. When the microphone terminal 15a includes two or more microphones, the microphone terminal 15a outputs the voice information collected with the respective microphones to the relay apparatus 50.

The camera 15b is a camera that shoots videos of the face of the speaker 2A. A shooting direction of the camera 15b is assumed to be preset. The camera 15b outputs video information on the face of the speaker 2A to the relay apparatus 50. The video information is information including multiple pieces of image information (still images) in time series.

The relay apparatus 50 transmits the voice information acquired from the microphone terminal 15a to the detection apparatus 300 through the network 60. The relay apparatus 50 transmits the video information acquired from the camera 15b to the detection apparatus 300 through the network 60.

The detection apparatus 300 receives the voice information and the video information from the relay apparatus 50. The detection apparatus 300 uses the video information in the case of detecting the first speech segment of the speaker 2A from the voice information. The detection apparatus 300 detects multiple voice segments from the voice information, and determines whether or not a phonatory organ (the mouth) of the speaker 2A is moving by analyzing the video information in time periods corresponding to the detected voice segments. The detection apparatus 300 detects each voice segment in the time period when the mouth of the speaker 2A is moving as the first speech segment.

Of the multiple voice segments included in the voice information, the voice segments in the time periods when the mouth of the speaker 2A is moving are deemed to be the first speech segments in which the speaker 2A is speaking. For example, it is possible to detect the first speech segments more accurately by using the video information on the speaker 2A shot with the camera 15b.

The detection apparatus 300 sets the search range based on the first speech segments as with the detection apparatus 100 of Embodiment 1, and detects the second speech segments of the second speaker based on the evaluation target acoustic features in the search range. The detection apparatus 300 transmits the voice information on the first speech segments and the voice information on the second speech segments to the voice recognition apparatus 400.

The voice recognition apparatus 400 receives the voice information on the first speech segments and the voice information on the second speech segments from the detection apparatus 300. The voice recognition apparatus 400 converts the voice information on the first speech segments into character strings and stores the character strings in the storage unit as character information on the store clerk in service. The voice recognition apparatus 400 converts the voice information on the second speech segments into character strings and stores the character strings in the storage unit as character information on the served customer.

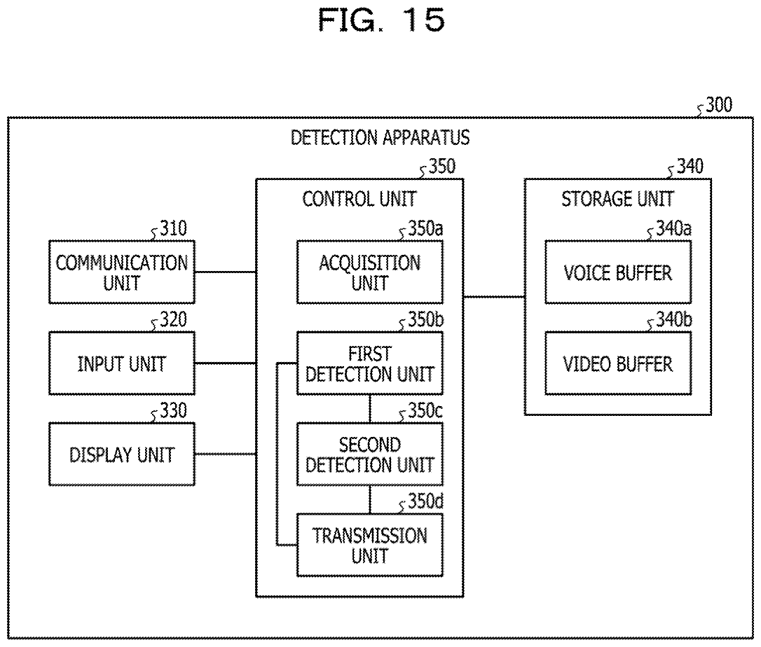

Next, a configuration of the detection apparatus 300 according to Embodiment 3 will be described. FIG. 15 is a functional block diagram illustrating a configuration of the detection apparatus according to Embodiment 3. As illustrated in FIG. 15, this detection apparatus 300 includes a communication unit 310, an input unit 320, a display unit 330, a storage unit 340, and a control unit 350.

The communication unit 310 is a processing unit which executes data communication with the relay apparatus 50 and the voice recognition apparatus 400. The communication unit 310 is an example of the communication device. The communication unit 310 receives the voice information and the video information from the relay apparatus 50 and outputs the received voice information and the received video information to the control unit 350. The communication unit 310 transmits information acquired from the control unit 350 to the voice recognition apparatus 400.

The input unit 320 is an input device used to input a variety of information to the detection apparatus 300. The input unit 320 corresponds to a keyboard, a mouse, a touch panel, and the like.

The display unit 330 is a display device that displays information outputted from the control unit 350. The display unit 330 corresponds to a liquid crystal display, a touch panel, and the like.

The storage unit 340 includes a voice buffer 340a and a video buffer 340b. The storage unit 340 corresponds to a semiconductor memory element such as a RAM and a flash memory, or a storage device such as an HDD.

The voice buffer 340a is a buffer that stores the voice information transmitted from the relay apparatus 50. In the voice information, a voice signal is associated with time.

The video buffer 340b is a buffer that stores the video information transmitted from the relay apparatus 50. The video information includes multiple pieces of image information, and each piece of image information is associated with the time.

The control unit 350 includes an acquisition unit 350a, a first detection unit 350b, a second detection unit 350c, and a transmission unit 350d. The control unit 350 is realized by any of a CPU, an MPU, a hardwired logic circuit such as an ASIC and an FPGA, and the like.

The acquisition unit 350a is a processing unit that acquires the voice information and the video information from the relay apparatus 50 through the communication unit 310. The acquisition unit 350a stores the voice information in the voice buffer 340a. The acquisition unit 350a stores the video information in the video buffer 340b.

The first detection unit 350b is a processing unit that detects the first speech segments of the speaker 2A (the first speaker) based on the voice information and the video information. The first detection unit 350b executes the voice segment detection processing, the acoustic analysis processing, and detection processing. The voice segment detection processing and the acoustic analysis processing to be executed by the first detection unit 350b is the same as the processing of the first detection unit 150b described in Embodiment 1.

An example of the “detection processing” to be executed by the first detection unit 350b will be described. The first detection unit 350b acquires pieces of the video information, which are shot in the respective voice segments detected in the voice segment detection processing, from the video buffer 340b. When the start time of an i-th voice segment is s and the end time thereof is eᵢ, for example, the pieces of video information corresponding to the i-th voice segment include pieces of the video information from the time sᵢ to the time eᵢ.

The first detection unit 350b detects a region of the mouth from a series of the pieces of image information included in the video information from the time sᵢ to the time eᵢ and determines whether or not the lips are moving up and down. When the lips are moving up and down from the time sᵢ to the time eᵢ, the first detection unit 350b detects the i-th voice segment as the first speech segment. Any technique may be used for the processing to detect the region of the mouth from the multiple pieces of image information and to detect the movement of the lips.

The first detection unit 350b repeatedly executes the above-described processing and outputs information on the first speech segment to the second detection unit 350c and the transmission unit 350d every time the first detection unit 350b detects the first speech segment. The information on the i-th first speech segment includes the start time Sᵢ of the i-th first speech segment and the end time Eᵢ of the i-th first speech segment.

The first detection unit 350b outputs the information, in which the respective frames included in the voice segments are associated with the evaluation target acoustic features, to the second detection unit 350c.

The second detection unit 350c is a processing unit that detects the second speech segments of the speaker 2B (the second speaker) among the multiple speakers based on the information on the first speech segments and based on the acoustic features of the voice information included in predetermined time ranges outside the first speech segments. The processing of the second detection unit 350c is the same as the processing of the second detection unit 150c described in Embodiment 1.

The second detection unit 350c outputs information on the respective second speech segments to the transmission unit 350d. The information on each second speech segment includes start time of the second speech segment and end time of the second speech segment.

The transmission unit 350d acquires the voice information included in each first speech segment from the voice buffer 340a based on the information on each first speech segment, and transmits the voice information on each first speech segment to the voice recognition apparatus 400. The transmission unit 350d acquires the voice information included in each second speech segment from the voice buffer 340a based on the information on each second speech segment, and transmits the voice information on each second speech segments to the voice recognition apparatus 400. In the following description, the voice information on each first speech segment will be referred to as “store clerk voice information”. The voice information on each second speech segment will be referred to as “customer voice information”.

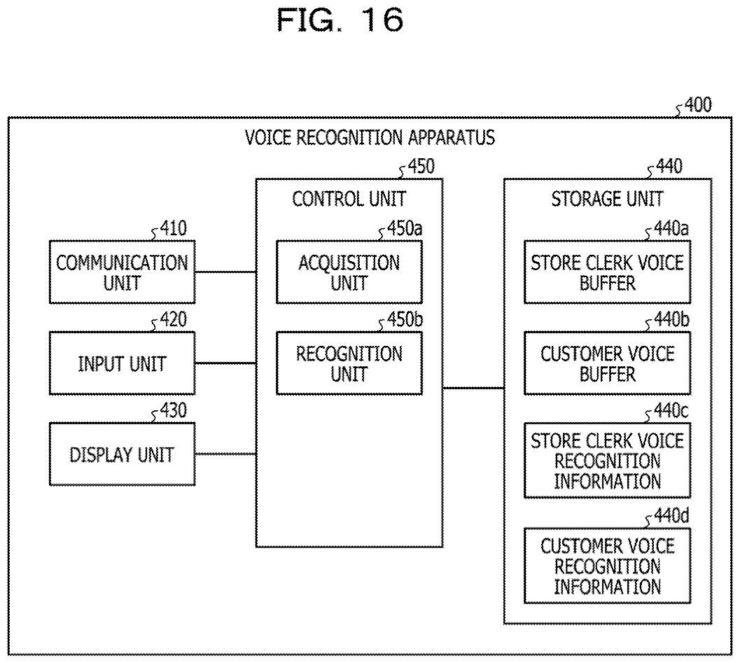

Next, a configuration of the voice recognition apparatus 400 will be described. FIG. 16 is a functional block diagram illustrating a configuration of the voice recognition apparatus according to Embodiment 3. As illustrated in FIG. 16, the voice recognition apparatus 400 includes a communication unit 410, an input unit 420, a display unit 430, a storage unit 440, and a control unit 450.

The communication unit 410 is a processing unit that executes data communication with the detection apparatus 300. The communication unit 410 is an example of the communication device. The communication unit 410 receives the store clerk voice information and the customer voice information from the detection apparatus 300. The communication unit 410 outputs the store clerk voice information and the customer voice information to the control unit 450.

The input unit 420 is an input device used to input a variety of information to the voice recognition apparatus 400. The input unit 420 corresponds to a keyboard, a mouse, a touch panel, and the like.

The display unit 430 is a display device that displays information outputted from the control unit 450. The display unit 430 corresponds to a liquid crystal display, a touch panel, and the like.

The storage unit 440 includes a store clerk voice buffer 440a, a customer voice buffer 440b, store clerk voice recognition information 440c, and customer voice recognition information 440d. The storage unit 440 corresponds to a semiconductor memory element such as a RAM and a flash memory, or a storage device such as an HDD.

The store clerk voice buffer 440a is a buffer that stores the store clerk voice information.

The customer voice buffer 440b is a buffer that stores the customer voice information.

The store clerk voice recognition information 440c is information obtained by converting the store clerk voice information on the first speech segments of the speaker 2A into character strings.

The store clerk voice recognition information 440c is information obtained by converting the customer voice information on the second speech segments of the speaker 2B into character strings.

The control unit 450 includes an acquisition unit 450a and a recognition unit 450b. The control unit 450 is realized by any of a CPU, an MPU, a hardwired logic circuit such as an ASIC and an FPGA, and the like.

The acquisition unit 450a is a processing unit that acquires the store clerk voice information and the customer voice information from the detection apparatus 300 through the communication unit 410. The acquisition unit 450a stores the store clerk voice information in the store clerk voice buffer 440a. The acquisition unit 450a stores the customer voice information in the customer voice buffer 440b.

The recognition unit 450b acquires the store clerk voice information stored in the store clerk voice buffer 440a, executes the voice recognition, and converts the store clerk voice information into character strings. The recognition unit 450b stores information on the converted character strings in the storage unit 440 as the store clerk voice recognition information 440c.

The recognition unit 450b acquires the customer voice information stored in the customer voice buffer 440b, executes the voice recognition, and converts the customer voice information into character strings. The recognition unit 450b stores information on the converted character strings in the storage unit 440 as the customer voice recognition information 440d.

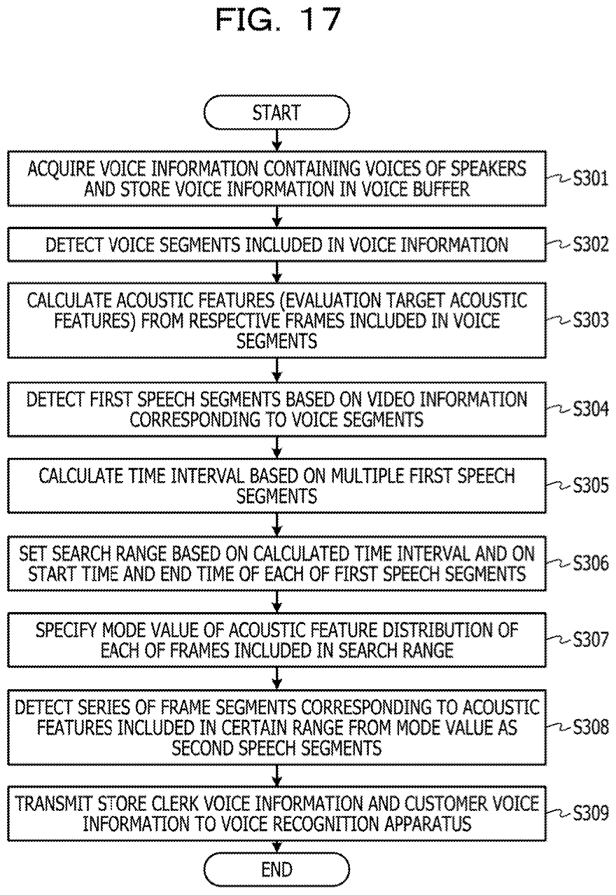

Next, an example of processing procedures of the detection apparatus 300 according to Embodiment 3 will be described. FIG. 17 is a flowchart illustrating the processing procedures of the detection apparatus according to Embodiment 3. As illustrated in FIG. 17, the acquisition unit 350a of the detection apparatus 300 acquires the voice information containing the voices of the multiple speakers and stores the information in the voice buffer 340a (step S301).

The first detection unit 350b of the detection apparatus 300 detects the voice segments included in the voice information (step S302). The first detection unit 350b calculates the acoustic features (the evaluation target acoustic features) from the respective frames included in the voice segments (step S303).

The first detection unit 350b detects the first speech segments based on the video information that corresponds to the voice segments (step S304). The second detection unit 350c of the detection apparatus 300 calculates the time interval based on the multiple first speech segments (step S305). The second detection unit 350c sets the search range based on the calculated time interval and on the start time and the end time of each of the first speech segments (step S306).

The second detection unit 350c specifies the mode value of the acoustic feature distribution of each of the frames included in the search range (step S307). The second detection unit 350c detects the series of frame segments corresponding to the acoustic features included in a certain range from the mode value as the second speech segments (step S308).

The transmission unit 350d of the detection apparatus 300 transmits the store clerk voice information and the customer voice information to the voice recognition apparatus 400 (step S309).

Next, effects of the detection apparatus 300 according to Embodiment 3 will be described. The detection apparatus 300 detects the multiple voice segments from the voice information, and determines whether or not the phonatory organ (the mouth) of the speaker 2A is moving by analyzing the video information in the time periods corresponding to the detected voice segments. The detection apparatus 300 detects each voice segment in the time period when the mouth of the speaker 2A is moving as the first speech segment.

Of the multiple voice segments included in the voice information, the voice segments in the time periods when the mouth of the speaker 2A is moving are deemed to be the first speech segments in which the speaker 2A is speaking. For example, it is possible to detect the first speech segments more accurately by using the video information on the speaker 2A shot with the camera 15b.

### Embodiment 4

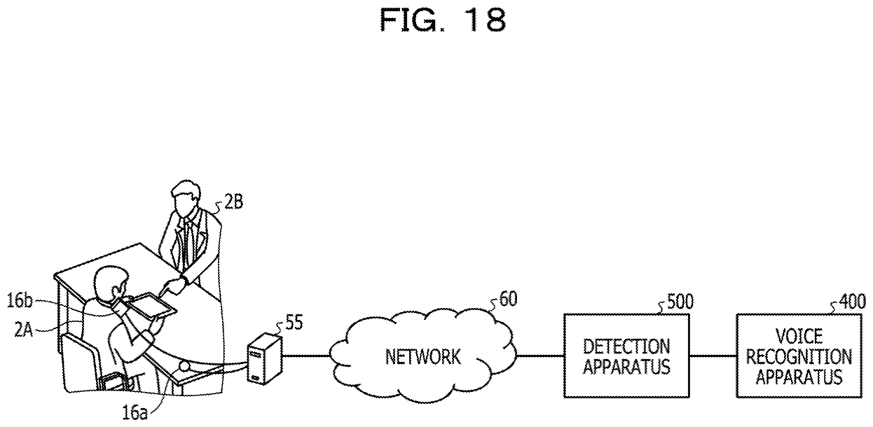

Next, a configuration of a system according to Embodiment 4 will be described. FIG. 18 illustrates an example of the system according to Embodiment 4. As illustrated in FIG. 18, this system includes a microphone terminal 16a, a contact-type vibration sensor 16b, a relay apparatus 55, a detection apparatus 500, and the voice recognition apparatus 400.

The microphone terminal 16a and the contact-type vibration sensor 16b are coupled to the relay apparatus 55. The relay apparatus 55 is coupled to the detection apparatus 500 through the network 60. The detection apparatus 500 is coupled to the voice recognition apparatus 400. The speaker 2A is assumed to be serving the speaker 2B near the microphone terminal 16a. The speaker 2A is assumed to be a store clerk and the speaker 2B is assumed to be a customer, for example. The speaker 2A represents an example of the first speaker. The speaker 2B represents an example of the second speaker. Other speakers (not illustrated) may be present around the speakers 2A and 26.

The microphone terminal 16a is a device that collects voices. The microphone terminal 16a transmits the voice information to the relay apparatus 55. The voice information contains information on the voices of the speakers 2A and 2B and other speakers. The microphone terminal 16a may include two or more microphones. When the microphone terminal 16a includes two or more microphones, the microphone terminal 16a outputs the voice information collected with the respective microphones to the relay apparatus 55.

The contact-type vibration sensor 16b is a sensor that detects vibration information on the phonatory organ of the speaker 2A. For example, the contact-type vibration sensor 16b is attached to a portion near the throat, the head, and the like of the speaker 2A. The contact-type vibration sensor 16b outputs the vibration information to the relay apparatus 55.

The relay apparatus 55 transmits the voice information acquired from the microphone terminal 16a to the detection apparatus 500 through the network 60. The relay apparatus 55 transmits the vibration information acquired from the contact-type vibration sensor 16b to the detection apparatus 500 through the network 60.

The detection apparatus 500 receives the voice information and the vibration information from the relay apparatus 55. The detection apparatus 500 uses the vibration information in the case of detecting the first speech segment of the speaker 2A from the voice information. The detection apparatus 500 detects the multiple voice segments from the voice information, and determines whether or not the phonatory organ (such as the throat) of the speaker 2A is vibrating by analyzing the vibration information in the time periods corresponding to the detected voice segments. The detection apparatus 500 detects each voice segment in the time period when the phonatory organ of the speaker 2A is vibrating as the first speech segment.

Of the multiple voice segments included in the voice information, the voice segments in the time periods when the phonatory organ of the speaker 2A is vibrating are deemed to be the first speech segments in which the speaker 2A is speaking. For example, it is possible to detect the first speech segments more accurately by using the vibration information on the speaker 2A sensed by the contact-type vibration sensor 16b.

The detection apparatus 500 sets the search range based on the first speech segments as with the detection apparatus 100 of Embodiment 1, and detects the second speech segments of the second speaker based on the evaluation target acoustic features in the search range. The detection apparatus 500 transmits the voice information on the first speech segments and the voice information on the second speech segments to the voice recognition apparatus 400.

The voice recognition apparatus 400 receives the voice information on the first speech segments and the voice information on the second speech segments from the detection apparatus 500. The voice recognition apparatus 400 converts the voice information on the first speech segments into character strings and stores the character strings in the storage unit as character information on the store clerk in service. The voice recognition apparatus 400 converts the voice information on the second speech segments into character strings and stores the character strings in the storage unit as character information on the served customer.

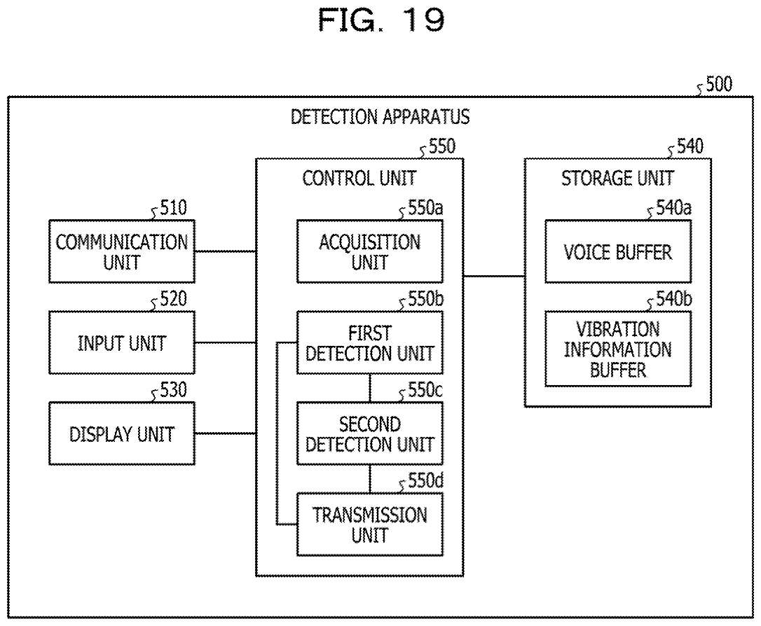

Next, a configuration of the detection apparatus 500 according to Embodiment 4 will be described. FIG. 19 is a functional block diagram illustrating a configuration of the detection apparatus according to Embodiment 4. As illustrated in FIG. 19, this detection apparatus 500 includes a communication unit 510, an input unit 520, a display unit 530, a storage unit 540, and a control unit 550.

The communication unit 510 is a processing unit which executes data communication with the relay apparatus 55 and the voice recognition apparatus 400. The communication unit 510 is an example of the communication device. The communication unit 510 receives the voice information and the vibration information from the relay apparatus 55 and outputs the received voice information and the received vibration information to the control unit 550. The communication unit 510 transmits information acquired from the control unit 550 to the voice recognition apparatus 400.

The input unit 520 is an input device used to input a variety of information to the detection apparatus 500. The input unit 520 corresponds to a keyboard, a mouse, a touch panel, and the like.

The display unit 530 is a display device that displays information outputted from the control unit 550. The display unit 530 corresponds to a liquid crystal display, a touch panel, and the like.

The storage unit 540 includes a voice buffer 540a and a vibration information buffer 540b. The storage unit 540 corresponds to a semiconductor memory element such as a RAM and a flash memory, or a storage device such as an HDD.

The voice buffer 540a is a buffer that stores the voice information transmitted from the relay apparatus 55. In the voice information, a voice signal is associated with time.

The vibration information buffer 540b is a buffer that stores the vibration information transmitted from the relay apparatus 55. In the vibration information, a signal indicating a vibration strength is associated with time.

The control unit 550 includes an acquisition unit 550a, a first detection unit 550b, a second detection unit 550c, and a transmission unit 550d. The control unit 550 is realized by any of a CPU, an MPU, a hardwired logic circuit such as an ASIC and an FPGA, and the like.

The acquisition unit 550a is a processing unit that acquires the voice information and the vibration information from the relay apparatus 55 through the communication unit 510. The acquisition unit 550a stores the voice information in the voice buffer 540a. The acquisition unit 550a stores the vibration information in the vibration information buffer 540b.

The first detection unit 550b is a processing unit that detects the first speech segments of the speaker 2A (the first speaker) based on the voice information and the vibration information. The first detection unit 550b executes the voice segment detection processing, the acoustic analysis processing, and detection processing. The voice segment detection processing and the acoustic analysis processing to be executed by the first detection unit 550b is the same as the processing of the first detection unit 150b described in Embodiment 1.

An example of the “detection processing” to be executed by the first detection unit 550b will be described. The first detection unit 550b acquires pieces of the vibration information, which are sensed in the respective voice segments detected in the voice segment detection processing, from the vibration information buffer 540b. When the start time of an i-th voice segment is s and the end time thereof is eᵢ, for example, the pieces of vibration information corresponding to the i-th voice segment include pieces of the vibration information from the time s to the time eᵢ.

The first detection unit 550b determines whether or not the vibration strength is equal to or above a predetermined strength out of a series of the pieces of vibration strengths included in the vibration information from the time s to the time eᵢ. When the vibration strengths are equal to or above the predetermined strength from the time s to the time eᵢ, the first detection unit 550b determines that the speaker 2A is speaking and detects the i-th voice segment as the first speech segment. For example, the first detection unit 550b may perform determination from the vibration information as to whether or not the speaker 2A is speaking by using the technique disclosed in Japanese Laid-open Patent Publication No. 2010-10869.

The first detection unit 550b repeatedly executes the above-described processing and outputs information on the first speech segment to the second detection unit 550c and the transmission unit 550d every time the first detection unit 550b detects the first speech segment. The information on the I-th first speech segment includes the start time Sᵢ of the i-th first speech segment and the end time Eᵢ of the i-th first speech segment.

The first detection unit 550b outputs the information, in which the respective frames included in the voice segments are associated with the evaluation target acoustic features, to the second detection unit 550c.

The second detection unit 550c is a processing unit that detects the second speech segments of the speaker 28 (the second speaker) among the multiple speakers based on the information on the first speech segments and based on the acoustic features of the voice information included in predetermined time ranges outside the first speech segments. The processing of the second detection unit 550c is the same as the processing of the second detection unit 150c described in Embodiment 1.

The second detection unit 550c outputs information on the respective second speech segments to the transmission unit 550d. The information on each second speech segment includes start time of the second speech segment and end time of the second speech segment.

The transmission unit 550d acquires the voice information included in each first speech segment from the voice buffer 540a based on the information on each first speech segment, and transmits the voice information on each first speech segment to the voice recognition apparatus 400. The transmission unit 550d acquires the voice information included in each second speech segment from the voice buffer 540a based on the information on each second speech segment, and transmits the voice information on each second speech segment to the voice recognition apparatus 400. In the following description, the voice information on each first speech segment will be referred to as “store clerk voice information”. The voice information on each second speech segment will be referred to as “customer voice information”.

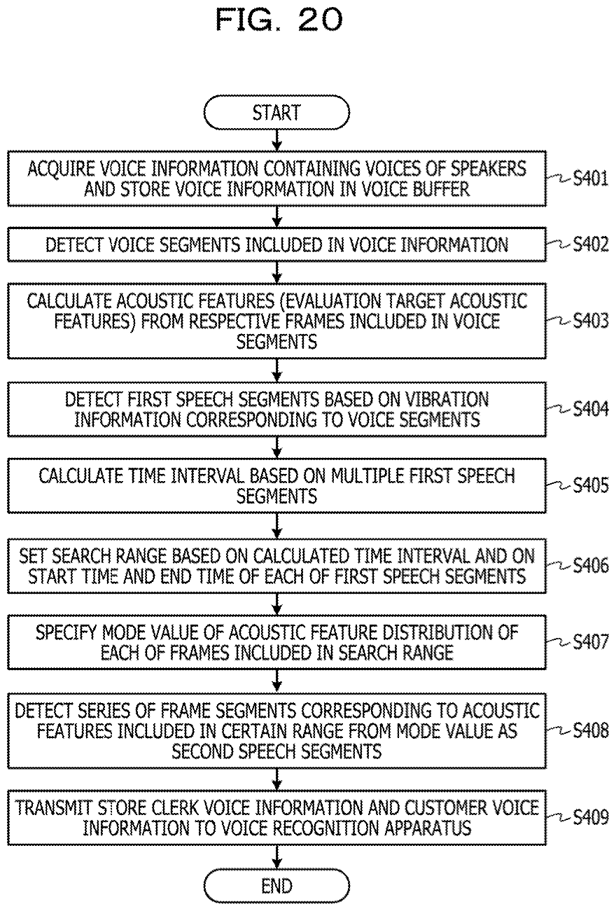

Next, an example of processing procedures of the detection apparatus 500 according to Embodiment 4 will be described. FIG. 20 is a flowchart illustrating the processing procedures of the detection apparatus according to Embodiment 4. As illustrated in FIG. 20, the acquisition unit 550a of the detection apparatus 500 acquires the voice information containing the voices of the multiple speakers and stores the information in the voice buffer 540a (step S401).

The first detection unit 550b of the detection apparatus 500 detects the voice segments included in the voice information (step S402). The first detection unit 550b calculates the acoustic features (the evaluation target acoustic features) from the respective frames included in the voice segments (step S403).

The first detection unit 550b detects the first speech segments based on the vibration information corresponding to the voice segments (step S404). The second detection unit 550c of the detection apparatus 500 calculates the time interval based on the multiple first speech segments (step S405). The second detection unit 550c sets the search range based on the calculated time interval and on the start time and the end time of each of the first speech segments (step S406).

The second detection unit 550c specifies the mode value of the acoustic feature distribution of each of the frames included in the search range (step S407). The second detection unit 550c detects the series of frame segments corresponding to the acoustic features included in a certain range from the mode value as the second speech segments (step S408).

The transmission unit 550d of the detection apparatus 500 transmits the store clerk voice information and the customer voice information to the voice recognition apparatus 400 (step S409).

Next, effects of the detection apparatus 500 according to Embodiment 4 will be described. The detection apparatus 500 detects the multiple voice segments from the voice information, and determines whether or not the phonatory organ of the speaker 2A is vibrating by analyzing the vibration information in the time periods corresponding to the detected voice segments. The detection apparatus 500 detects each voice segment in which the phonatory organ of the speaker 2A is vibrating as the first speech segment.

Of the multiple voice segments included in the voice information, the voice segments in the time periods when the phonatory organ of the speaker 2A is vibrating are deemed to be the first speech segments in which the speaker 2A is speaking. For example, it is possible to detect the first speech segments more accurately by using the vibration information on the speaker 2A sensed by the contact-type vibration sensor 16b.

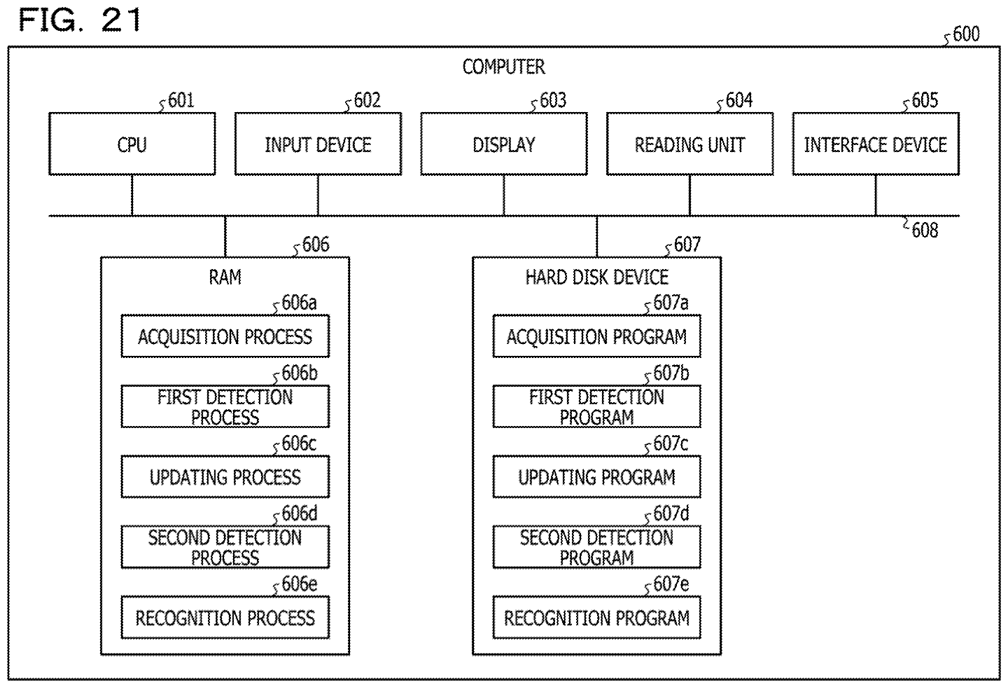

Next, an example of a hardware configuration of a computer that implements the same functions as those of the detection apparatuses 100, 200, 300, and 500 illustrated in the embodiments will be described. FIG. 21 illustrates an example of the hardware configuration of the computer that implements the same functions as those of the detection apparatus.

As illustrated in FIG. 21, a computer 600 includes a CPU 601 that executes various arithmetic processing, an input device 602 that accepts input of data from a user, and a display 603. The computer 600 includes a reading device 604 which reads a program and the like from a recording medium, and an interface device 605 which acquires data from the microphone, the camera, the vibration sensor, and the like through a wired or wireless network. The computer 600 includes a RAM 606 that temporarily stores a variety of information, and a hard disk device 607. The respective devices 601 to 607 are coupled to a bus 608.

The hard disk device 607 includes an acquisition program 607a, a first detection program 607b, an updating program 607c, a second detection program 607d, and a recognition program 607e. The CPU 601 reads the acquisition program 607a, the first detection program 607b, the updating program 607c, the second detection program 607d, and the recognition program 607e and develops these programs in the RAM 606.

The acquisition program 607a functions as an acquisition process 606a. The first detection program 607b functions as a first detection process 606b. The updating program 607c functions as an updating process 606c. The second detection program 607d functions as a second detection process 606d. The recognition program 607e functions as a recognition process 606e.

Processing in the acquisition process 606a corresponds to the processing of each of the acquisition units 150a, 250a, 350a, and 550a. Processing in the first detection process 606b corresponds to the processing of each of the first detection units 150b, 250b, 350b, and 550b. Processing in the updating process 606c corresponds to the processing of the updating unit 250c. Processing in the second detection process 606d corresponds to the processing of each of the second detection units 150c, 250d, 350c, and 550c. Processing in the recognition process 606e corresponds to the processing of each of the recognition units 150d and 250e.

The respective programs 607a to 607e do not have to be stored in the hard disk device 607 from the beginning. For example, the respective programs may be stored in a “portable physical medium” to be inserted into the computer 600, such as a flexible disk (FD), a CD-ROM, a DVD, a magneto-optical disc, and an IC card. The computer 600 may read and execute the programs 607a to 607e.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium for storing a detection program which causes a processor to perform processing, the processing comprising:
acquiring voice information containing voices of a plurality of speakers;
detecting a first speech segment of a first speaker among the plurality of speakers included in the voice information based on a first acoustic feature of the first speaker, the first acoustic feature being obtained by performing a machine learning; and
detecting a second speech segment of a second speaker among the plurality of speakers based on a second acoustic feature, the second acoustic feature being an acoustic feature included in the voice information associated with a predetermined time range, the predetermined time range being a time range outside the first speech segment.

2. The non-transitory computer-readable storage medium according to claim 1, wherein
the detecting of a first speech segment is configured to detect the first speech segment based on a similarity of the learned acoustic feature to an acoustic feature included in the voice information.

3. The non-transitory computer-readable storage medium according to claim 1, causing the computer to execute the processing further comprising:
updating the learned acoustic feature based on an acoustic feature of the first speech segment.

4. The non-transitory computer-readable storage medium according to claim 1, wherein
any of video information on a face or a phonatory organ of the first speaker and vibration information on the phonatory organ is acquired, and
the detecting of a first speech segment is configured to detect the first speech segment by using any of the video information and the vibration information.

5. The non-transitory computer-readable storage medium according to claim 1, the processing further comprising:
calculating an average value of time intervals each ranging from a point of detection of the first speech segment to a point of detection of a subsequent first speech segment in the detecting a first speech segment; and
setting the predetermined time range based on the average value.

6. The non-transitory computer-readable storage medium according to claim 5, the processing further comprising:
calculating an average segment length of a plurality of the first speech segments;
increasing the predetermined time range when the corresponding first speech segment is shorter than the average segment length; and
reducing the predetermined time range when the corresponding first speech segment is equal to or longer than the average segment length.

7. The non-transitory computer-readable storage medium according to claim 1, wherein
the detecting of a second speech segment is configured to
specify a mode value of the acoustic feature in a plurality of frames included in the predetermined time range outside the first speech segment, and
detect, as the second speech segment, the segment including the frame being close to the mode value.

8. The non-transitory computer-readable storage medium according to claim 1, wherein
the detecting of a second speech segment is configured to
obtain a mode value of a similarity of the first acoustic feature and the second acoustic feature,
obtain a threshold corresponding to the obtained mode value, and
detect the second speech segment by using the obtained threshold.

9. A detection method implemented by a computer, the detection method comprising:
acquiring voice information containing voices of a plurality of speakers;
detecting a first speech segment of a first speaker among the plurality of speakers included in the voice information based on a first acoustic feature of the first speaker, the first acoustic feature being obtained by performing a machine learning; and
detecting a second speech segment of a second speaker among the plurality of speakers based on a second acoustic feature, the second acoustic feature being an acoustic feature included in the voice information associated with a predetermined time range, the predetermined time range being a time range outside the first speech segment.

10. A detection apparatus comprising:
a memory; and
a processor coupled to the memory, the processor being configured to
acquire voice information containing voices of a plurality of speakers,
detect a first speech segment of a first speaker among the plurality of speakers included in the voice information based on a first acoustic feature of the first speaker, the first acoustic feature being obtained by performing a machine learning, and
detect a second speech segment of a second speaker among the plurality of speakers based on a second acoustic feature, the second acoustic feature being an acoustic feature included in the voice information associated with a predetermined time range, the predetermined time range being a time range outside the first speech segment.
